(19) United States
(12) Patent Application Publication
(10) Pub. No.: US 2003/0046209 A1
(43) Pub. Date: Mar. 6, 2003

(54) Financial asset manager selection and peer group information dissemination method, system and computer-readable medium therefor

(75) Inventors: Benjamin Brandenberger, Hiltenbergstrasse2 (CH); Michael Brandenberger, Othmarstrasse 22 (CH); Felix Kottmann, Seewydenstrasse 13 (CH)

Correspondence Address: GREENBLUM & BERNSTEIN, P.L.C., 1941 ROLAND CLARKE PLACE, RESTON, VA, 20191, US

(73) Assignee: managerselection. com Inc., St. Gallen (CH)

(21) Appl. No.: 09/931,721

(22) Filed: Aug. 20, 2001

(51) Int. Cl. G06F 17/60

(52) U.S. Cl. 705/36

(57) ABSTRACT

A financial asset manager peer group information dissemination method, system and computer-readable medium therefor is provided. The method includes accessing a database, entering asset manager data in a section of an asset manager questionnaire, the asset manager questionnaire including a plurality of sections. The method further includes sorting, in the database, entered asset manager data from the questionnaire, comparing asset manager data with data of at least another asset manager, and generating a manager report of the compared data corresponding to the plurality of sections for the asset manager and the at least another asset manager.

### BACKGROUND OF THE INVENTION

1. Field of the Invention

The present invention is related to a method, system and computer-readable medium for the selection of a financial asset manager, and more particularly relates to such a method, system and computer-readable medium that provides financial asset manager peer group information.

2. Background and Material Information

Investors, particularly institutional investors, hire external asset managers (asset management houses such as banks, specialist companies, insurance companies and the like) to manage their securities portfolios (e.g., fixed income, equity, real estate, commodity, private equity and the like). Since the performance of asset managers often is less than their real market potential or the targets set by the investor, inventors often release and hire different asset managers. Many asset managers undergo a test period generally ranging from 2-3 years. If the asset manager is unsuccessful, the search begins for a different, more successful manager.

Generally, these investors hire an independent consulting company to provide advice and support in finding an asset manager for the desired asset category or environment. These consulting companies distribute printed questionnaires to asset management houses, which have large teams dedicated to answering these questionnaires. Standardizing these printed questionnaires has been proposed, but has not been implemented to date. Thus, answering these questionnaires requires a great deal of time and other expenditures, and is often a waste of time since the same data must be reproduced for each individual questionnaire.

Aside from the high cost, other disadvantages of the above-described manager selection process is the lack of transparency, as well as the bias towards preferred asset management partners, existing shortlists and the potential for kickbacks due to relationships between consultants and asset managers. Also, the above-described selection process is also heavily influenced by manager names and reputations, rather than their actual performance, thereby often compromising the subjectivity of the consultant. Additionally, this time-consuming and paper-based process is often narrow, failing to cover the broadest universe of asset managers.

There is presently no unbiased and in-depth overview available on the true value of asset managers' products individually and their positioning within the universe regarding performance, fees, risk etc. A web-based platform offering a structured database on a large number of asset managers and their products is thus desired as the ideal tool to provide this information continuously to demanding investors and consultants.

There are several interactive online manager selection systems which provide online questionnaires to asset managers in an attempt to automate the manager selection process. Such systems may be found at http://www.investorforce.com, http://www.plansponsor.com and http://www.eFrontiers.com (the latter being defunct). However, none of these systems provide a way for asset managers to see how their organization and investment products perform with respect to those of other asset managers (i.e., the asset managers are given no feedback about competing asset managers), and thus cannot easily tailor, position or modify their organization, products or product management methods based on market demands.

There is thus a need for an efficient, unbiased and cost-effective system of selecting asset managers that provides feedback to managers.

### SUMMARY OF THE INVENTION

The present invention reduces time and effort in selecting asset managers. Additionally, the present invention provides transparency and objectivity to the manager selection process. Further, feedback regarding competing asset managers is provided to regularly-participating asset managers. Additionally, the present invention provides a broad universe of asset managers by combining different search tools. Also, the present invention provides regularly-updated, standardized electronic questionnaires, thereby reducing the workload for asset managers and streamlining the manager selection process.

The present invention allows asset managers to register with the interactive system thereof, to download the electronic questionnaire and submit their product data. Registering, downloading the questionnaire and submitting data may be free of charge. Also, there may be no fee to be paid by the asset manager when appointed by an investor using the database for his selection process. Preferably, there is a maximum of seven traditional products (e.g., equity, bonds, convertible bonds, and the like), also referred to as “flagship products” and three “non-traditional” products (e.g., hedge funds, private equity and the like) for submission by the asset manager.

“Flagship products” are products (segregated accounts, funds etc.) such as US equities, European bonds etc. These products are categorized by their asset category and subcategory, the asset category including the type of asset (e.g., bonds, equity and the like) and their national origin or currency. Examples of product asset categories are Euro bonds, Japanese yen equity, and the like. The subcategory provides a more detailed definition of type or product area, such as growth, value, and growth at a reasonable price (GARP).

The participation of any asset manager with one or more of his or her products in the database may be free of charge, the goal being to attract as many asset management companies as possible worldwide to compose a comprehensive database.

Asset managers may submit data for as many products as they wish (generally 7 traditional and 3 non-traditional products). Different continental branches of asset management companies may submit their choice of products for each branch. The data submitted may be stored on the asset manager's own computer. Therefore, managers can modify data on the questionnaire without being forced to complete the same questionnaires again and again.

The questionnaires focus on nearly all relevant areas of asset management. Furthermore, the entire process is done electronically and information requested for submission by the asset managers is directed towards data analysis and analytics.

Asset managers may change their flagship product data any time. An individual track record of changes made by each asset manager may be produced. The periodic updates of the data on the asset managers and their products (performance, statistical data, process and the like) may be done directly by the asset managers on their data files and then submitted to the database. Therefore, each asset manager is responsible for all data submitted and for regular updates.

Further, the present invention provides an online peer-group-analysis to participant asset managers, allowing them to compare the full range of each submitted products with similar products of other asset managers (i.e, the applicable universe). Also, the peer-group-report is accessible online. The fees for analysis may be charged annually to subscribing asset managers. Subscription to the service is voluntary and has no influence on any other activities within the database.

The peer-group-analysis allows asset managers to receive detailed feedback on the position of products submitted by each asset manager within the applicable universe. The report contains comparisons of the organizational structure of the asset managers in their respective universes, comparisons of realized performances of products in similar respective categories, comparisons of risk measures, fees, type of performance (composite, certified, etc.) and the like. Thus, an asset manager is always able to view the latest data, as well as charts and graphs showing comparisons in various categories between the asset manager and other asset managers. The analyses may thus help a manager position his/her/its products within the universe of competitors' products. Further, asset manager data in the database is anonymous and analyses are produced with a great deal of discretion. The asset manager only sees where his/her/its own products are situated compared to competitors' products.

Data provided by asset managers through the questionnaire that appear as exceptional are questioned, and the asset manager in question will be asked to provide an external audit by a well-known auditor.

In addition to asset managers, investors, generally institutional investors (e.g., pension funds and high net worth individuals), and consultants may register with the system of the present invention to be able to access the database thereof. Browsing the database of the present invention may be free of charge, but there may be a charge of US $500.00 every time an investor or consultant accesses the contact information of an asset manager.

Instead of the names of the asset managers, the present invention only allows the investor and consultant to view codes, in order to avoid any misuse of the asset managers' data, which can be guaranteed only by not providing any details about the managers' identity in advance. To guarantee the highest level of objectivity in a search, it is best not to disclose asset managers' identities initially to prevent any name-biased pre-exclusion of managers. The whole selection process is thus based on facts and figures, not on manager names and reputations.

Furthermore, investors and consultants have access to a checklist-type of recipes on how to select an asset manager, which helps investors and consultants proceed step-by-step without overlooking important elements in the search process.

The selection process is driven by an evaluation platform where investors and/or consultants may weigh nearly all parameters available (performance, risk, tracking error, information ratio and the like) based on their individual needs and strategies. The individual “optimal list” will be rebalanced every time when weightings are revised in order to produce the relevant ranking for the selector. Besides being able to put together individual and ranked optimal lists of best in class products, a profile of every asset manager is made available to investors and consultants. The profile contains additional information on the asset manager's investment philosophy and processes, as well as company information and the like.

Preferably, the investor or consultant should use IPE-Quest (an asset manager toolbox) to ensure that a complete asset manager search has been performed as broadly as possible.

Once an investor or consultant has put together a final optimal list and analyzed the asset manager profiles in which they are interested, investors and consultants will have the opportunity to open the contact information of favorite asset managers with whom to conduct interviews, and finally appoint the most appropriate manager with the mandate of the investor or consultant. There is generally no fee charged to the asset manager for being appointed. Generally, the only fee charged to investors and consultants is for opening the asset manager's contact information.

The financial asset manager peer group information dissemination method of the present invention includes accessing a database, entering asset manager data in a section of an asset manager questionnaire, the asset manager questionnaire including a plurality of sections, and sorting, in the database, entered asset manager data from the questionnaire. The method further includes comparing asset manager data with data of at least another asset manager and generating a manager report of the compared data corresponding to the plurality of sections for the asset manager and the at least another asset manager.

The method may also include displaying, in the manager report, of at least one of median, smallest and largest value of the compared data for at least one section of the plurality of sections for the asset manager and the at least another asset manager. Also, the method may include displaying a comparison, in the manager report, of the compared data for at least one section of the plurality of sections. Additionally, the manager report may be configured to be exported into a spreadsheet program.

The method of the present invention may further include downloading the electronic asset manager questionnaire from the database, and uploading, to a database, the asset manager questionnaire including entered asset manager data, wherein the entering of asset manager data occurs in the downloaded questionnaire.

Also, the sections of the questionnaire may include at least one of organization information, products managed by the asset manager, and product details. Further, a comparison may be displayed in the manager report of at least one of organization information, products, and product details of the asset manager and the at least another asset manager. Additionally, a comparison may be displayed in the manager report of at least one of performance, risk measures, fees and volume of the asset manager's and the at least another asset manager's respective products.

Further, the method of the invention may further include displaying, in the manager report, information on the asset manager's and the at least another asset manager's respective assets under management, active portfolio volume, number of accounts active, passive portfolio volume, number of passive accounts, and preferences for a product custodian.

Additionally, the product section may include at least one category that is one of equity bonds, hedge funds and commodities. Further, the at least one category of the product section may include at least one subcategory being one of growth, value, and growth at a reasonable price (GARP).

Still further, the product details section may include at least one category being one of product specification, assets under management, responsible portfolio manager, account size and cost, investment team, investment philosophy, reference list, management style, decision factors, actively steered parameters, approach for passive products, expected results, historic results, and performance data and standards.

The method of the invention may also include entering, by a an investor, data corresponding to a plurality of investor preferences corresponding to at least one of the plurality of categories and subcategories; entering, by the investor, data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees; and matching the data corresponding to the entered plurality of investor preferences and the entered criteria with asset manager data and data entered by the at least another asset manager; and generating an investor report based on the matched data, the investor report including a code corresponding to the asset manager and the at least another asset manager, wherein the investor is not informed of the identity of the asset manager and the at least another asset manager.

Still yet, the method may include generating a manager feedback analysis report including factors determined important by the investor, based on the data corresponding to the entered plurality of investor preferences and the entered criteria, for a successful selection of an asset manager by the investor. Also, the factors may include at least one of quantitative factors, qualitative factors, and data quality.

The system of the present invention includes a database, an asset manager questionnaire including a plurality of sections, the asset manager questionnaire configured to accept asset manager data in a section, a sorter for sorting, in the database, accepted asset manager data from the questionnaire, a comparer for comparing asset manager data with data of at least another asset manager, and a manager report including compared data corresponding to the plurality of sections for the asset manager and the at least another asset manager.

The manager report may further include at least one of median, smallest and largest value of the compared data for at least one section of the plurality of sections for the asset manager and the at least another asset manager. Also the manager report may further include a comparison of the compared data for at least one section of the plurality of sections. The manager report may also be exported into a spreadsheet program.

Further, the questionnaire may be configured to be downloaded from the database, and the database may accept uploaded asset manager questionnaires including accepted asset manager data, and wherein the acceptance of asset manager data may occur in the downloaded questionnaire. The sections of the questionnaire may include at least one of organization information, products managed by the asset manager, and product details.

The manager report may further include a comparison of at least one of organization information, products, and product details of the asset manager and the at least another asset manager. Also, the manager report may further provide a comparison of at least one of performance, risk measures, fees and volume of the asset manager's and the at least another asset manager's respective products.

The manager report may yet further include information on the asset manager's and the at least another asset manager's respective assets under management, active portfolio volume, number of accounts active, passive portfolio volume, number of passive accounts, and preferences for a product custodian. The product section may include at least one category being one of equity bonds, hedge funds and commodities. The at least one category of the product section may include at least one subcategory being one of growth, value, and growth at a reasonable price (GARP).

Additionally, the product details section may include at least one category being one of product specification, assets under management, responsible portfolio manager, account size and cost, investment team, investment philosophy, reference list, management style, decision factors, actively steered parameters, approach for passive products, expected results, historic results, and performance data and standards.

The database of the system of the present invention may also have a first acceptor for accepting first data entered by an investor, the first data corresponding to a plurality of investor preferences corresponding to at least one of the plurality of categories and subcategories; a second acceptor for accepting second data entered by an investor, the second data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees; and a matcher for matching the first data corresponding to the entered plurality of investor preferences and the second data corresponding to entered criteria with asset manager data and data entered by the at least another asset manager. The system may further include an investor report based on the matched data, the investor report including a code corresponding to the asset manager and the at least another asset manager, wherein the investor is not informed of the identity of the asset manager and the at least another asset manager.

A manager feedback analysis report including factors determined important by the investor, based on the data corresponding to the entered plurality of investor preferences and the entered criteria, for a successful selection of an asset manager by the investor, may also be provided. The factors may include at least one of quantitative factors, qualitative factors, and data quality.

The computer-readable medium of the present invention includes a system for accessing a database, an asset manager questionnaire including a plurality of sections, the asset manager questionnaire configured to accept asset manager data in a section, a sorter for sorting, in the database, accepted asset manager data from the questionnaire, a system for comparing asset manager data with data of at least another asset manager, and a manager report including compared data corresponding to the plurality of sections for the asset manager and the at least another asset manager.

The manager report may further include at least one of median, smallest and largest value of the compared data for at least one section of the plurality of sections for the asset manager and the at least another asset manager. Also, the manager report may further include a comparison of the compared data for at least one section of the plurality of sections. The manager report may also be exported into a spreadsheet program.

Further, the questionnaire may be configured to be downloaded from the database, and the database may accept uploaded asset manager questionnaires including accepted asset manager data, and wherein the acceptance of asset manager data may occur in the downloaded questionnaire. The sections of the questionnaire may include at least one of organization information, products managed by the asset manager, and product details.

The manager report may further include a comparison of at least one of organization information, products, and product details of the asset manager and the at least another asset manager. Also, the manager report may further provide a comparison of at least one of performance, risk measures, fees and volume of the asset manager's and the at least another asset manager's respective products.

The manager report may yet further include information on the asset manager's and the at least another asset manager's respective assets under management, active portfolio volume, number of accounts active, passive portfolio volume, number of passive accounts, and preferences for a product custodian. The product section may include at least one category being one of equity bonds, hedge funds and commodities. The at least one category of the product section may includes at least one subcategory being one of growth, value, and growth at a reasonable price (GARP).

Additionally, the product details section may include at least one category being one of product specification, assets under management, responsible portfolio manager, account size and cost, investment team, investment philosophy, reference list, management style, decision factors, actively steered parameters, approach for passive products, expected results, historic results, and performance data and standards.

The database may also have a first acceptor for accepting first data entered by an investor, the first data corresponding to a plurality of investor preferences corresponding to at least one of the plurality of categories and subcategories; a second acceptor for accepting second data entered by an investor, the second data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees; and a system for matching the first data corresponding to the entered plurality of investor preferences and the second data corresponding to entered criteria with asset manager data and data entered by the at least another asset manager. The medium may further include an investor report based on the matched data, the investor report including a code corresponding to the asset manager and the at least another asset manager, wherein the investor is not informed of the identity of the asset manager and the at least another asset manager.

A manager feedback analysis report including factors determined important by the investor, based on the data corresponding to the entered plurality of investor preferences and the entered criteria, for a successful selection of an asset manager by the investor, may also be provided. The factors may include at least one of quantitative factors, qualitative factors, and data quality.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of preferred embodiments of the present invention, in which like numerals represent like elements throughout the several views of the drawings, and wherein:

FIG. 1 shows a main page of the present invention;

FIG. 2 shows a manager member area page of the present invention;

FIG. 3 shows a first page of a questionnaire of the present invention;

FIG. 4 shows a second page of a questionnaire of the present invention;

FIG. 5 shows a third page of a questionnaire of the present invention;

FIG. 6 shows a fourth page of a questionnaire of the present invention;

FIG. 7 shows a fifth page of a questionnaire of the present invention;

FIG. 8 shows a sixth page of a questionnaire of the present invention;

FIG. 9 shows a seventh page of a questionnaire of the present invention;

FIG. 10 shows a eighth page of a questionnaire of the present invention;

FIG. 11 shows a ninth page of a questionnaire of the present invention;

FIG. 12 shows a tenth page of a questionnaire of the present invention;

FIG. 13 shows a eleventh page of a questionnaire of the present invention;

FIG. 14 shows a twelfth page of a questionnaire of the present invention;

FIG. 15 shows a thirteenth page of a questionnaire of the present invention;

FIG. 16 shows a fourteenth page of a questionnaire of the present invention;

FIG. 17 shows a fifteenth page of a questionnaire of the present invention;

FIG. 18 shows a sixteenth page of a questionnaire of the present invention;

FIG. 19 shows a seventeenth page of a questionnaire of the present invention;

FIG. 20 shows a eighteenth page of a questionnaire of the present invention;

FIG. 21 shows a nineteenth page of a questionnaire of the present invention;

FIG. 22 shows a twentieth page of a questionnaire of the present invention;

FIG. 23 shows a twenty-first page of a questionnaire of the present invention;

FIG. 24 shows a twenty-second page of a questionnaire of the present invention;

FIG. 25 shows a twenty-third page of a questionnaire of the present invention;

FIG. 27 shows a twenty-fourth page of a questionnaire of the present invention;

FIG. 28 shows a twenty-fifth page of a questionnaire of the present invention;

FIG. 29 shows a twenty-sixth page of a questionnaire of the present invention;

FIG. 30 shows a block diagram of the setup of the present invention;

FIG. 31 shows a manager database access login screen;

FIG. 32 shows a manager database welcome page;

FIG. 33 shows a first example of an organizational peer group report of the present invention;

FIG. 34 shows a second example of an organizational peer group report of the present invention;

FIG. 35 shows a third example of an organizational peer group report of the present invention;

FIG. 36 shows a fourth example of an organizational peer group report of the present invention;

FIG. 37 shows a fifth example of an organizational peer group report of the present invention;

FIG. 38 shows a sixth example of an organizational peer group report of the present invention;

FIG. 39 shows a first example of a product peer group report of the present invention;

FIG. 40 shows a second example of a product peer group report of the present invention;

FIG. 41 shows a third example of a product peer group report of the present invention;

FIG. 42 shows a fourth example of a product peer group report of the present invention;

FIG. 43 shows a fifth example of a product peer group report of the present invention;

FIG. 44 shows a sixth example of a product peer group report of the present invention;

FIG. 45 shows a seventh example of a product peer group report of the present invention;

FIG. 46 shows an eighth example of a product peer group report of the present invention;

FIG. 47 shows a ninth example of a product peer group report of the present invention;

FIG. 48 shows a tenth example of a product peer group report of the present invention;

FIG. 49 shows a eleventh example of a product peer group report of the present invention;

FIG. 50 shows a twelfth example of a product peer group report of the present invention;

FIG. 51 shows a thirteenth example of a product peer group report of the present invention;

FIG. 52 shows a fourteenth example of a product peer group report of the present invention;

FIG. 53 shows a fifteenth example of a product peer group report of the present invention;

FIG. 54 shows a sixteenth example of a product peer group report of the present invention;

FIG. 55 shows a seventeenth example of a product peer group report of the present invention;

FIG. 56 shows a eighteenth example of a product peer group report of the present invention;

FIG. 57 shows an example of a spreadsheet of a peer group report of the present invention;

FIG. 58 shows an investor/consultant welcome page of the present invention;

FIG. 59 shows an investor member area page of the present invention;

FIG. 60 shows an investor search page of the present invention;

FIG. 61 shows an evaluation page of the present invention;

FIG. 62 shows a products screen of the present invention;

FIG. 63 shows a example of an investor report of the present invention;

FIG. 64 shows an example of a spreadsheet of an investor report of the present invention;

FIG. 65 shows an example of a monthly performance graph of the present invention;

FIG. 66 shows an example of a portrait section of an investor report of the present invention;

FIG. 67 shows an example of a portrait report of the present invention;

FIG. 68 shows another example of a portrait report of the present invention;

FIG. 69 shows a page of an asset manager feedback analysis report of the present invention;

FIG. 70 shows an example of a feedback analysis table of the present invention;

FIG. 71 shows an example of a feedback analysis commentary of the present invention; and

FIGS. 72a and 72b show a flowchart explaining an operation of a system of the present invention.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

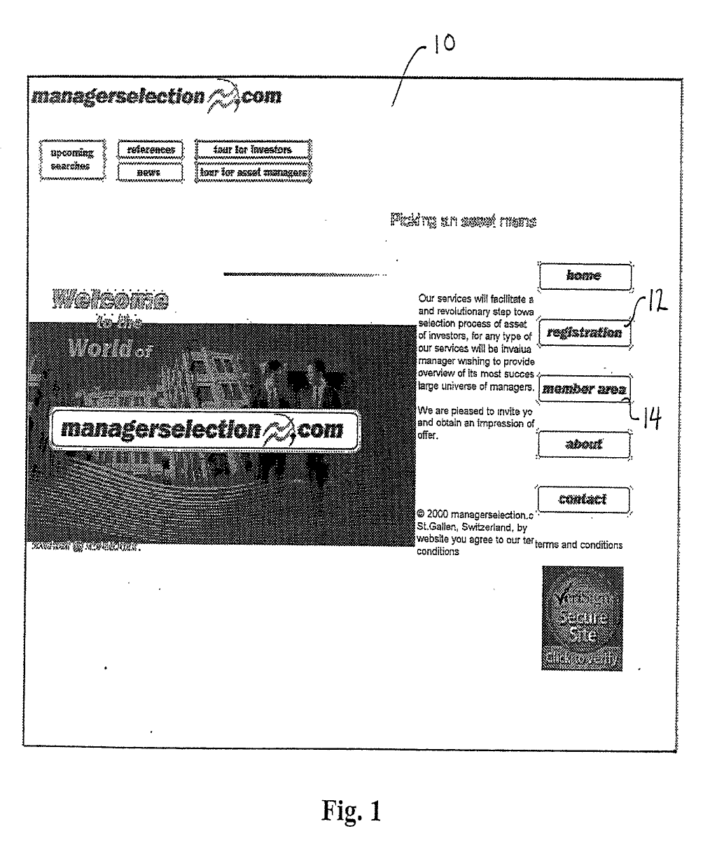

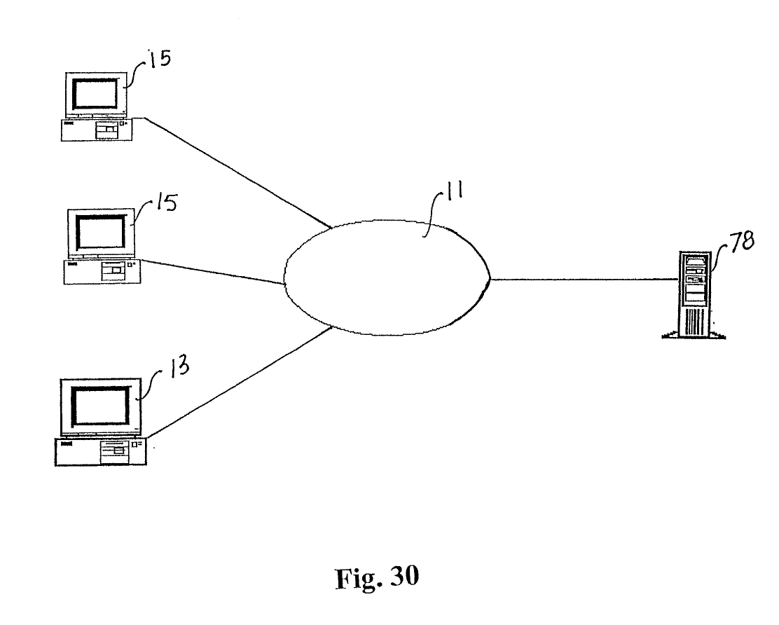

Referring to the drawings wherein like numerals represent like elements, FIG. 1 shows a main “webpage” 10 that an operator such as an asset manager, investor or consultant is presented with upon accessing the system of the present invention. As shown in FIG. 30, the system uses a database 78 that is connected in two-way communication with a network 11 such as the World Wide Web (WWW), a Wide Area Network (WAN), but may be accessed over other networks in alternative embodiments.

An operator may view the main webpage 10 by entering the URL (for example http://www.managerselection.com) in an operator's web browser (e.g., Netscape, Microsoft Internet Explorer, and the like) in an operator's computer 13, 15.

Upon accessing the main webpage 10, an operator is shown “buttons” that give the operator choices for accessing other aspects of the system of the present invention, such as registration 12 and member area 14. If the operator is new, then the operator registers by preferably “clicking” a pointing device (e.g., a mouse) in an area of the browser displaying the registration “button” 12, whereupon the operator is prompted to enter data required for registering for the system of the present invention.

If the operator is already a member, the operator clicks on the member area button 14 and is taken to a member area page (not shown), where the operator enters his or her user name and password. The operator has access to one of two main areas of the system of the present invention, depending on whether the operator is an investor, consultant or asset manager. The system of the present invention determines, based upon the username, whether the operator is an investor, consultant, or asset manager, and directs the operator to the appropriate location of the system of the present invention. For purposes of simplicity, operators that are investors, consultants or in any way act on behalf of an investor are hereinafter collectively referred to as “investors.”

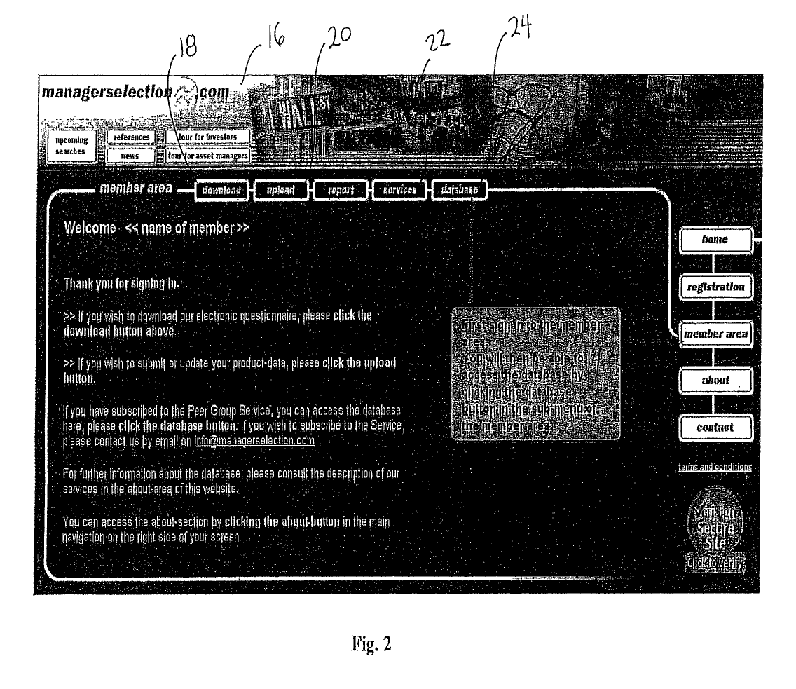

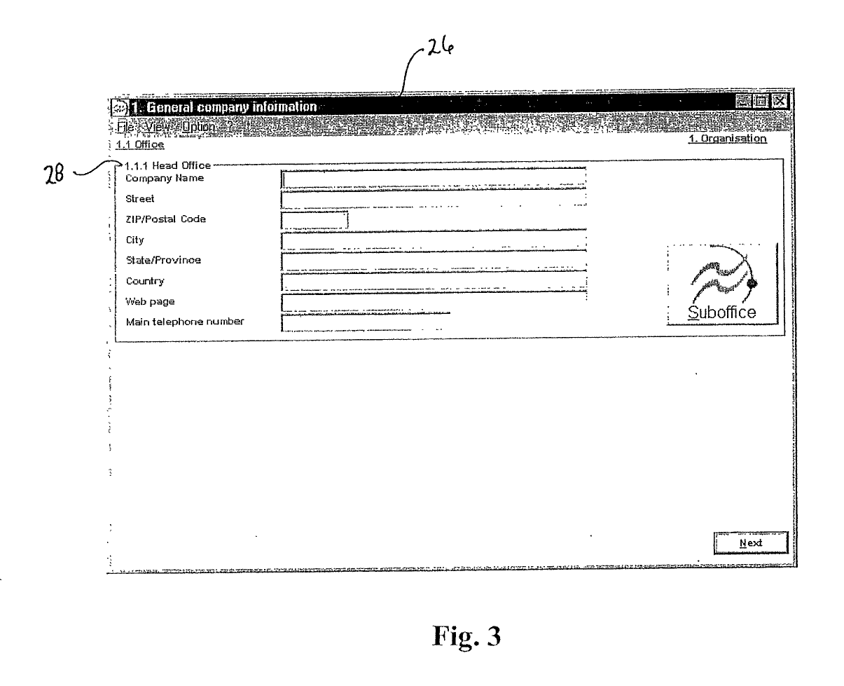

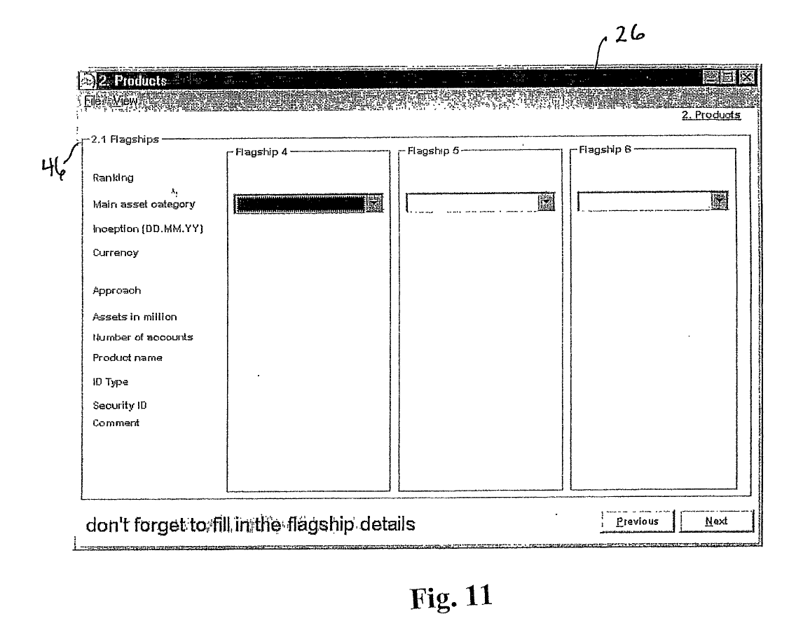

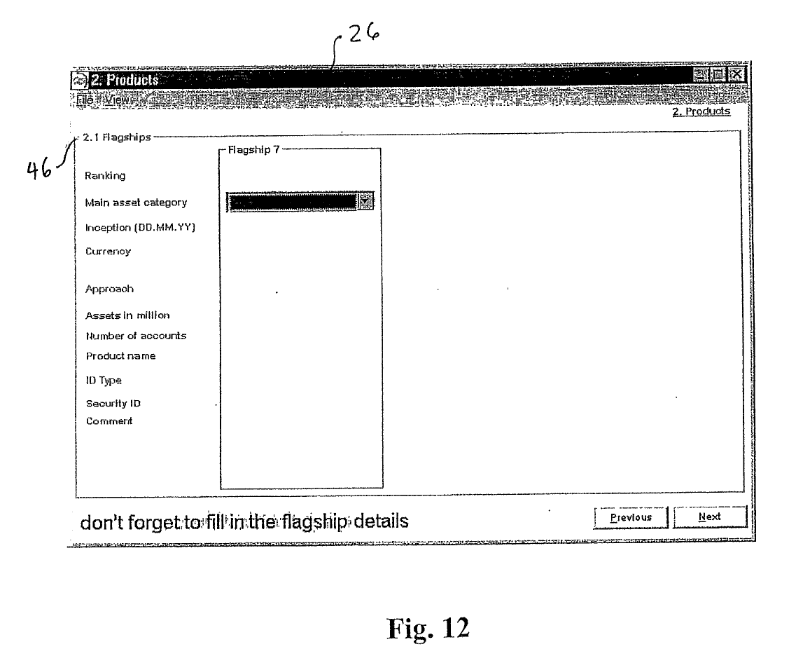

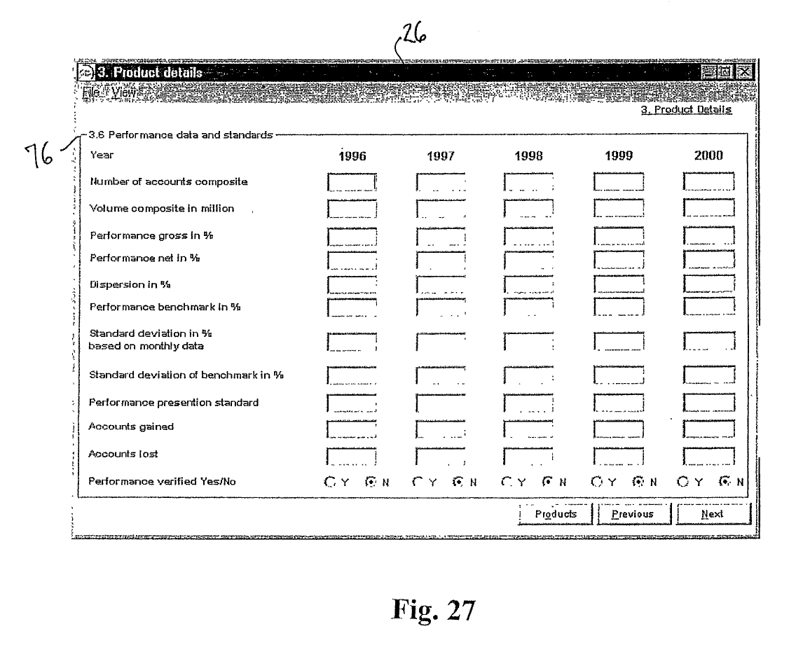

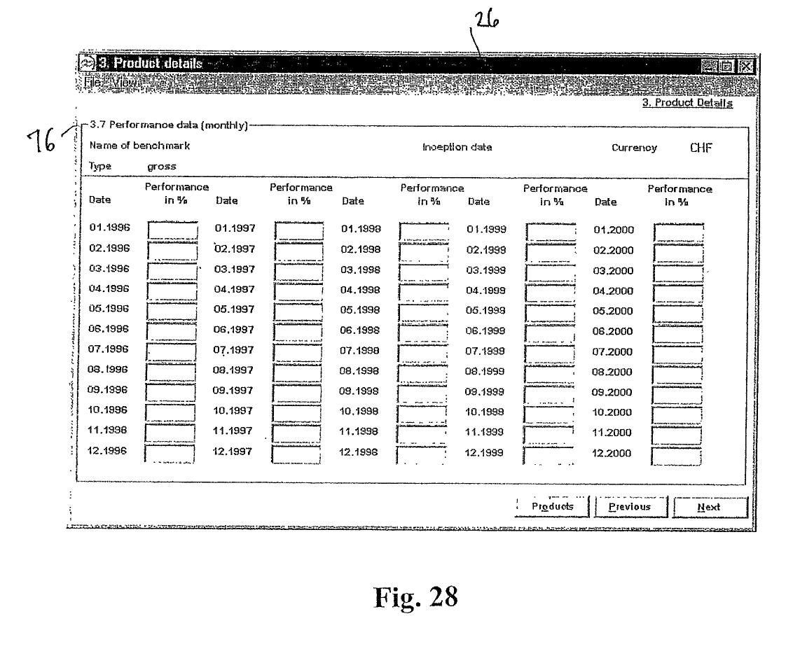

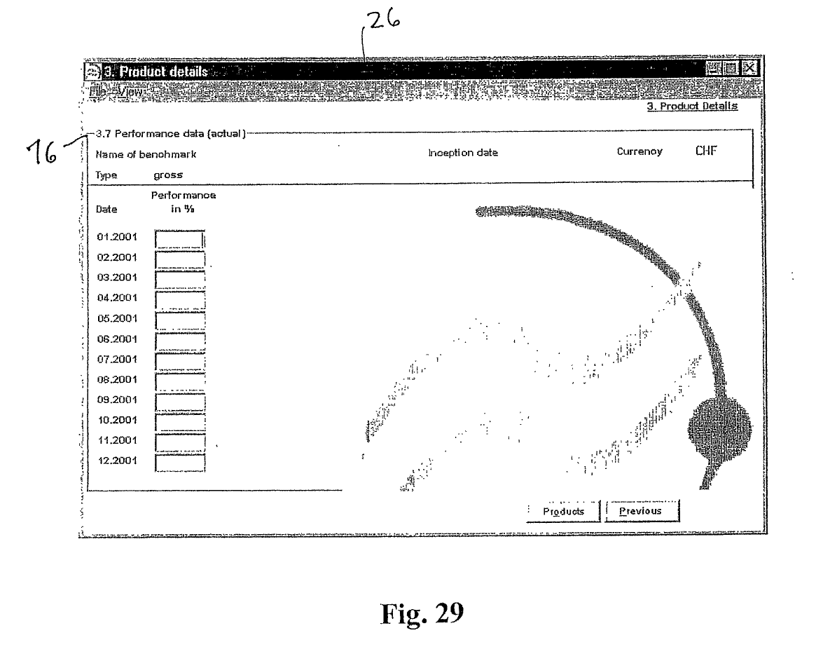

If the operator is an asset manager or asset management house (also referred to as “manager”), the manager is presented with the manager member area page, shown as 16 in FIG. 2, wherein a variety of buttons are presented, including download 18, upload 20, services 22 and database 24. If the manager is newly registered, the manager may download an electronic questionnaire 26, the electronic screen pages of which are shown in FIGS. 3-29, by clicking on the download button 18.

Preferably, the questionnaire 26 is a Microsoft Visual Basic application, but may be created using other software in alternative embodiments. The questionnaire 26 is preferably downloaded to the manager's own computer 13, whereupon data may be entered in the various fields therein. However, in alternative embodiments, data may also be filled out online without downloading the questionnaire. When the questionnaire 26 is downloaded to the manager's computer, a data storage file (not shown) is also created in the manager's computer 13. Every time the manager enters or updates data, it is saved in the data storage file.

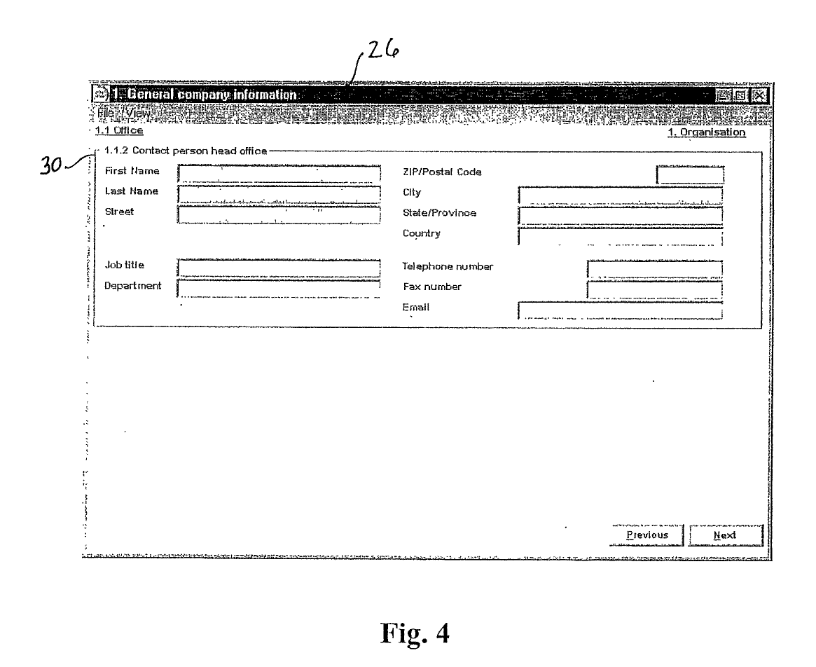

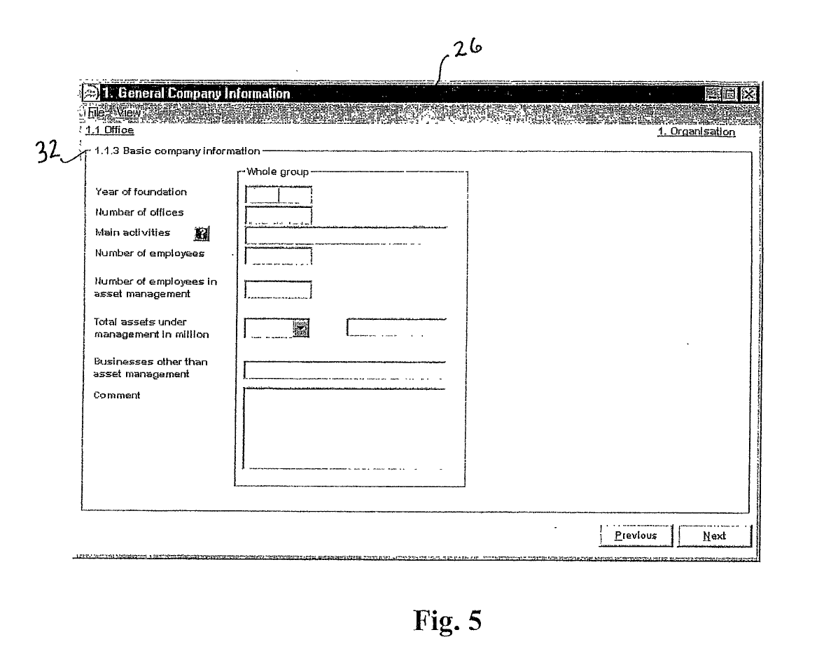

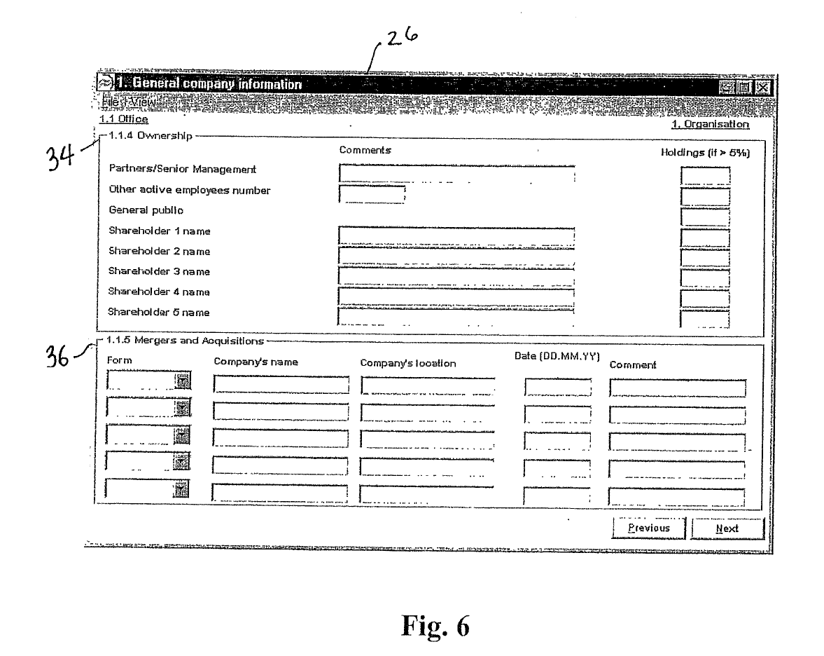

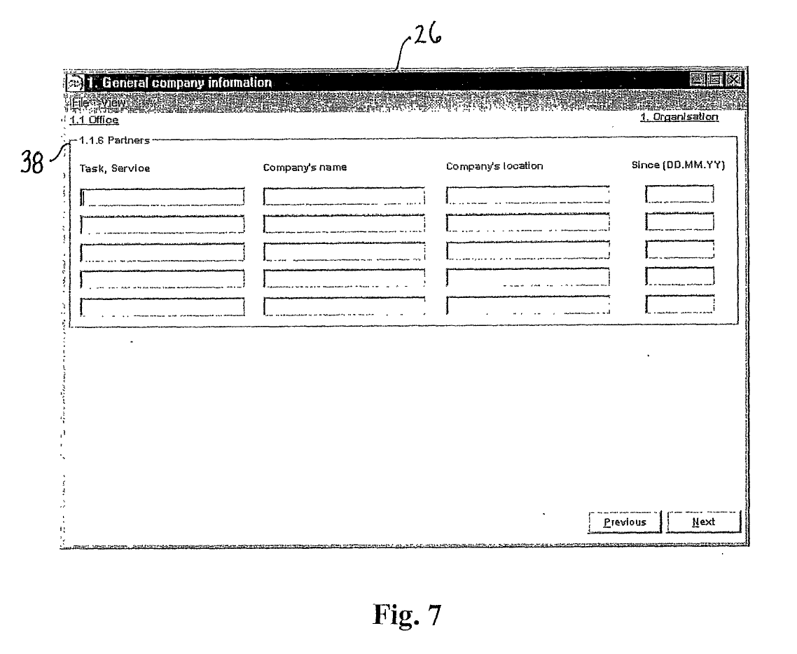

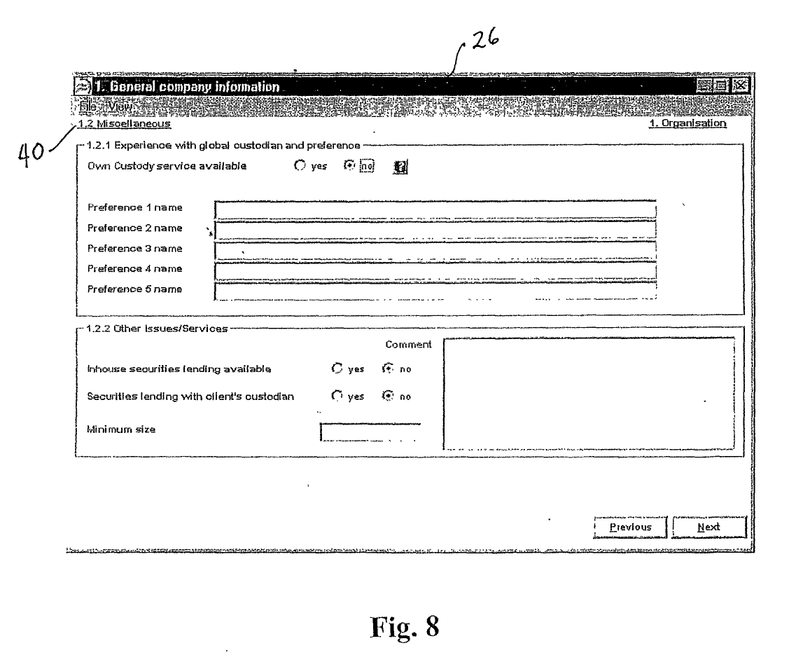

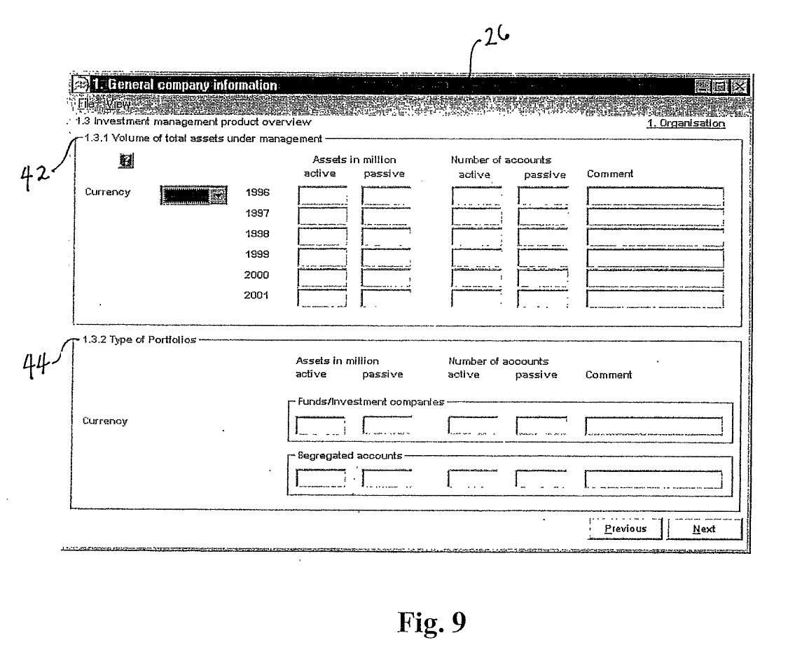

The questionnaire 26, as shown in FIGS. 3-29, contains fields for the manager to enter data therein. Preferably, fields requiring mandatory data entry are yellow, while data entry is optional for white fields. In FIGS. 3-9, the manager may enter data generally relating to the company or organization, such as location of the head office 28 (FIG. 3), contact people 30 (FIG. 4), basic company information 32 (FIG. 5), office ownership 34 and mergers and acquisitions 36 (FIG. 6), partners 38 (FIG. 7), miscellaneous issues 40 (FIG. 8), and volume of assets under management 42 and types of portfolios 44 (FIG. 9).

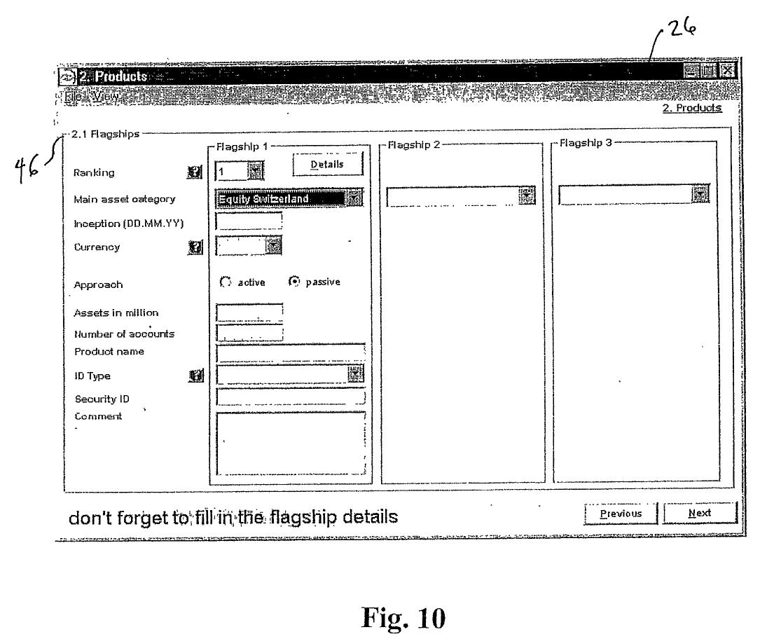

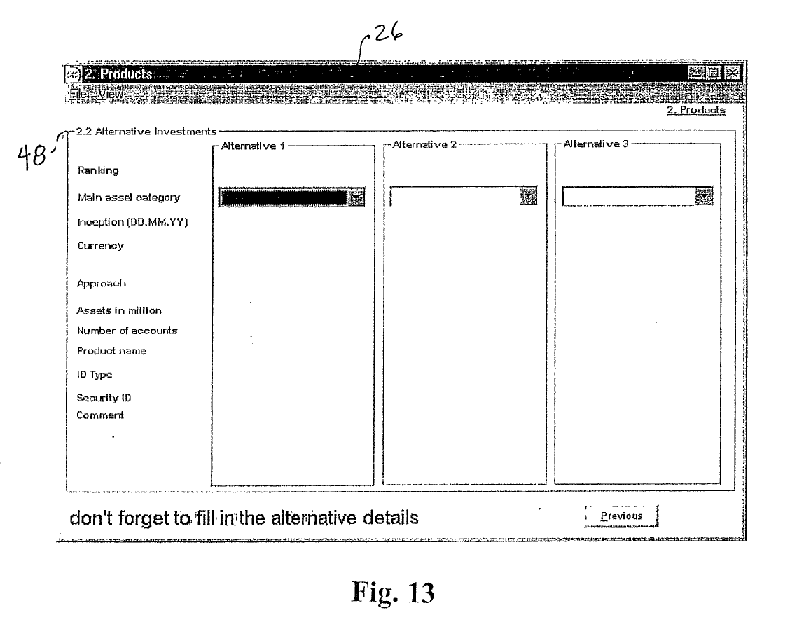

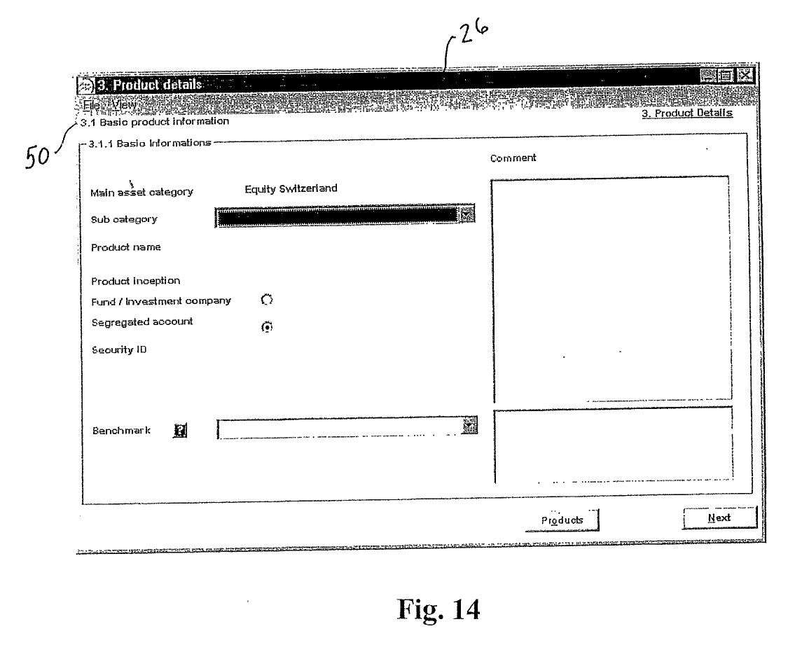

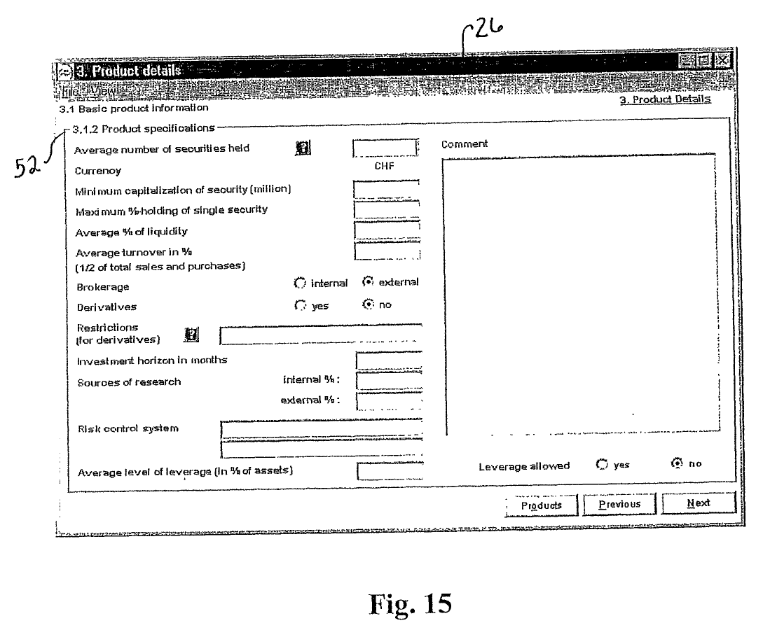

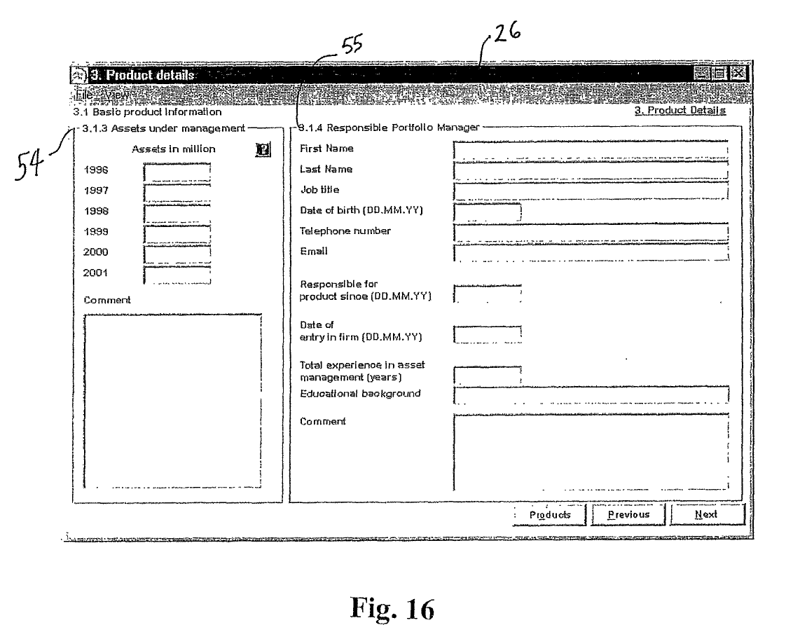

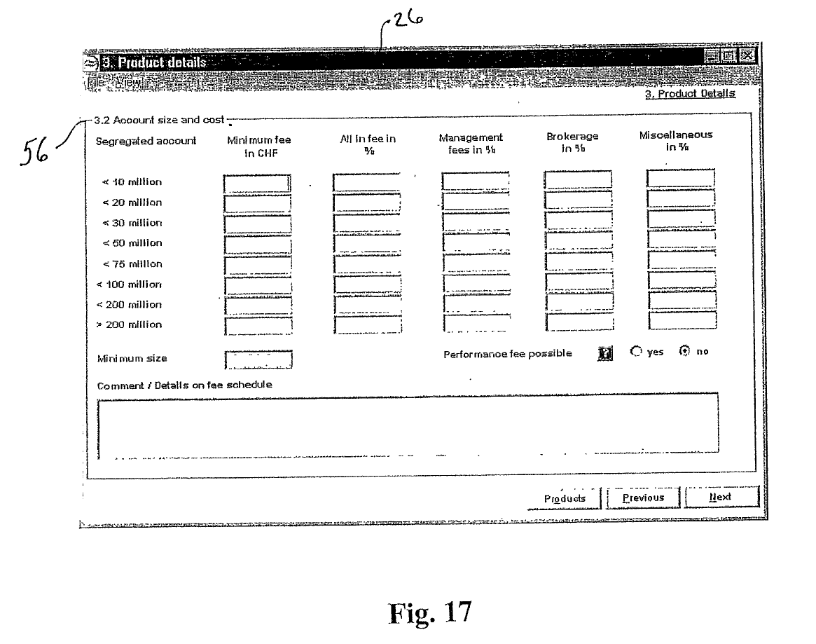

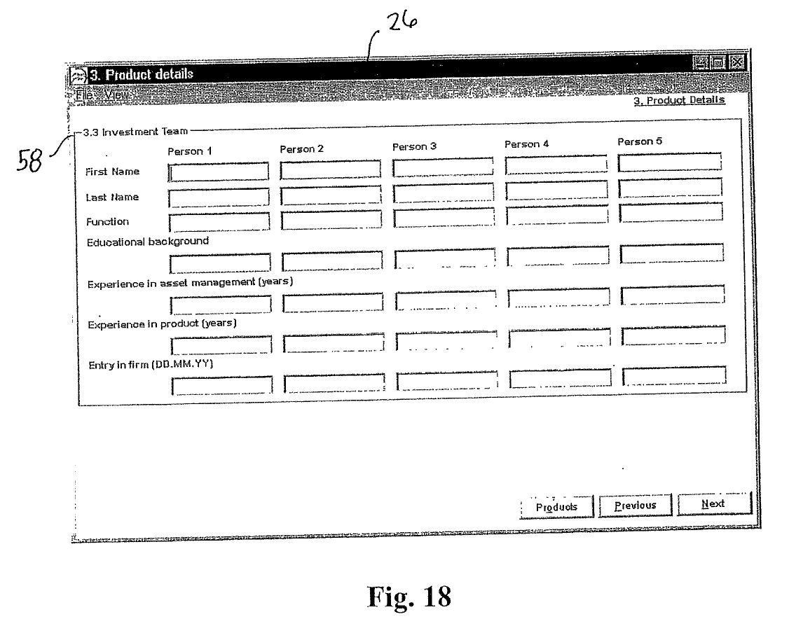

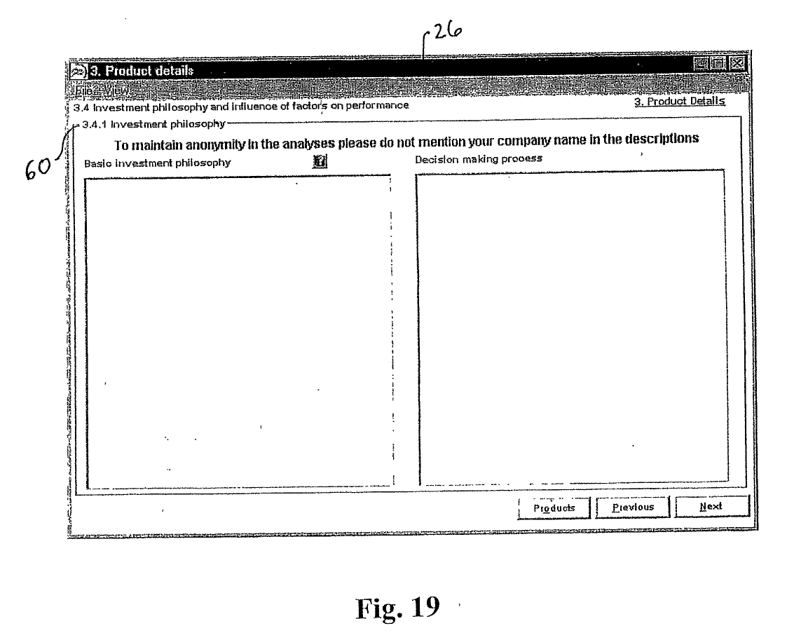

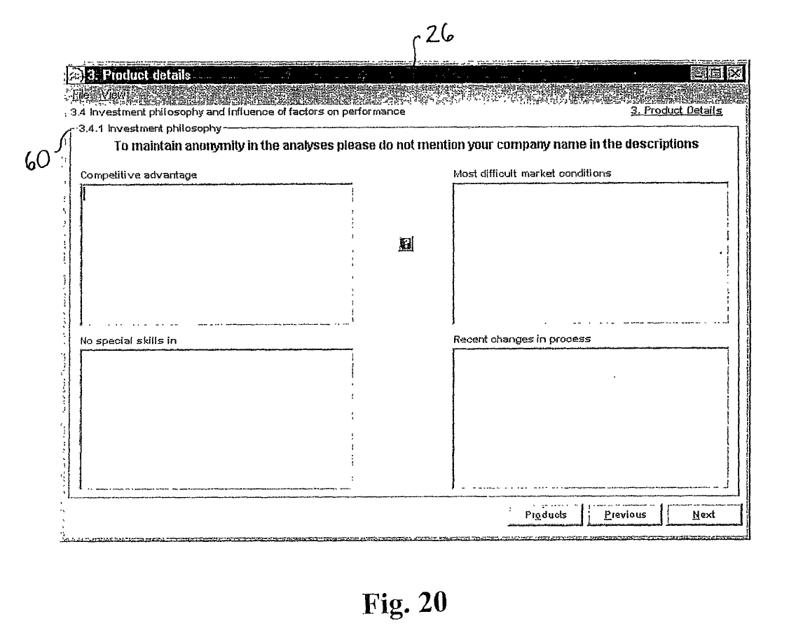

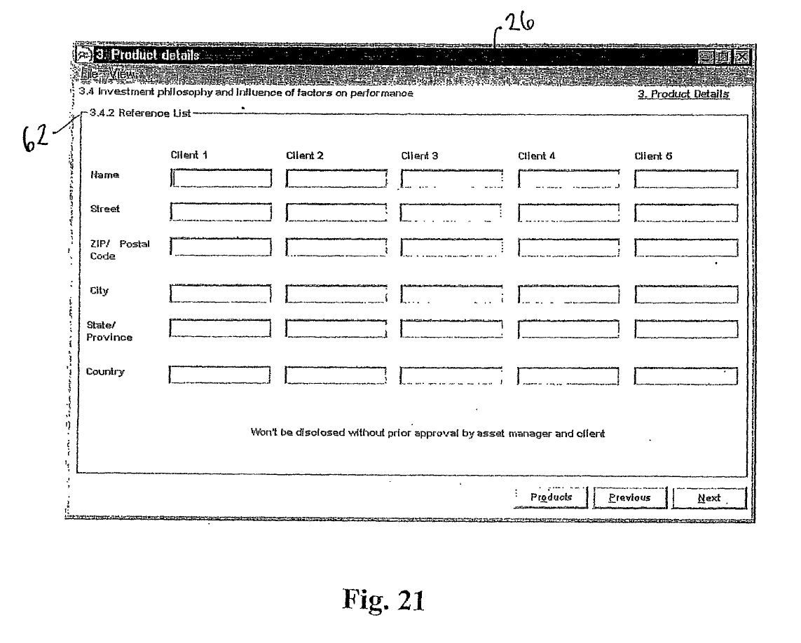

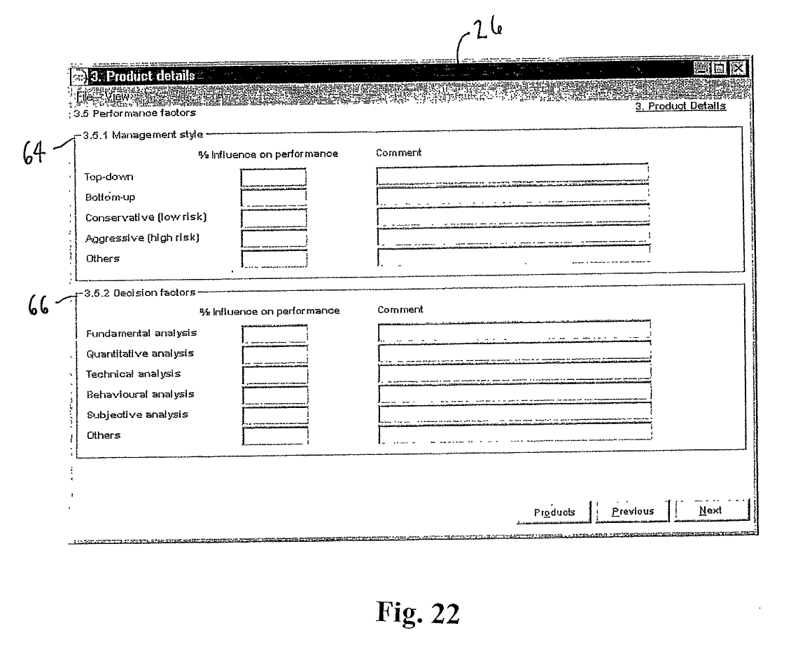

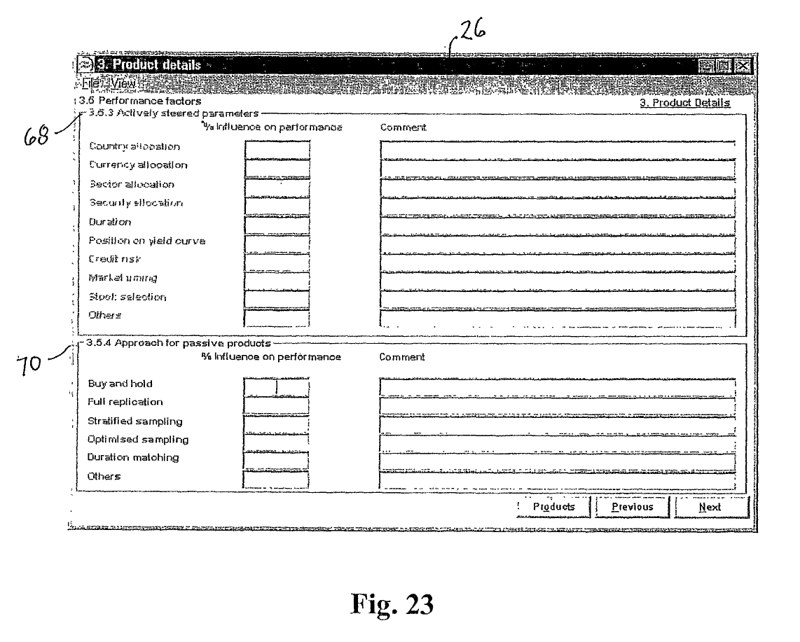

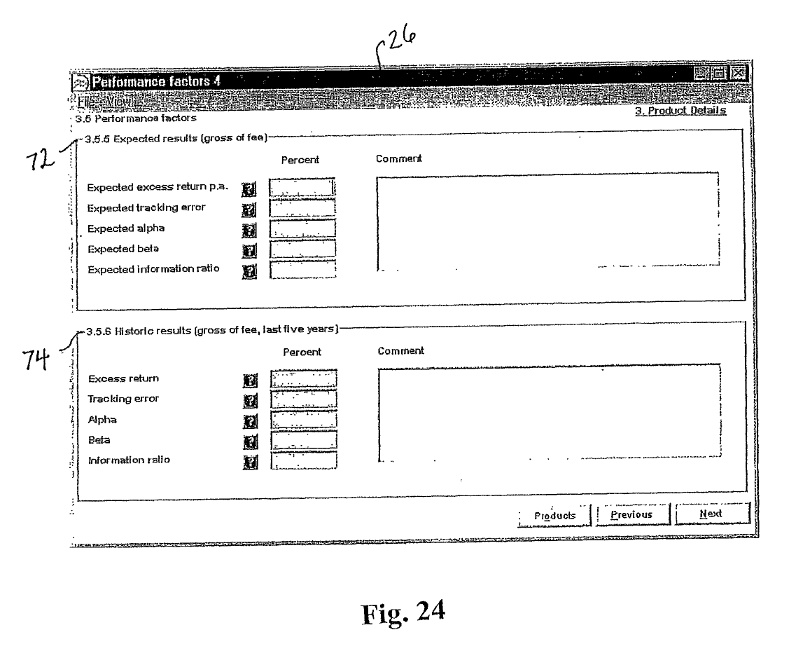

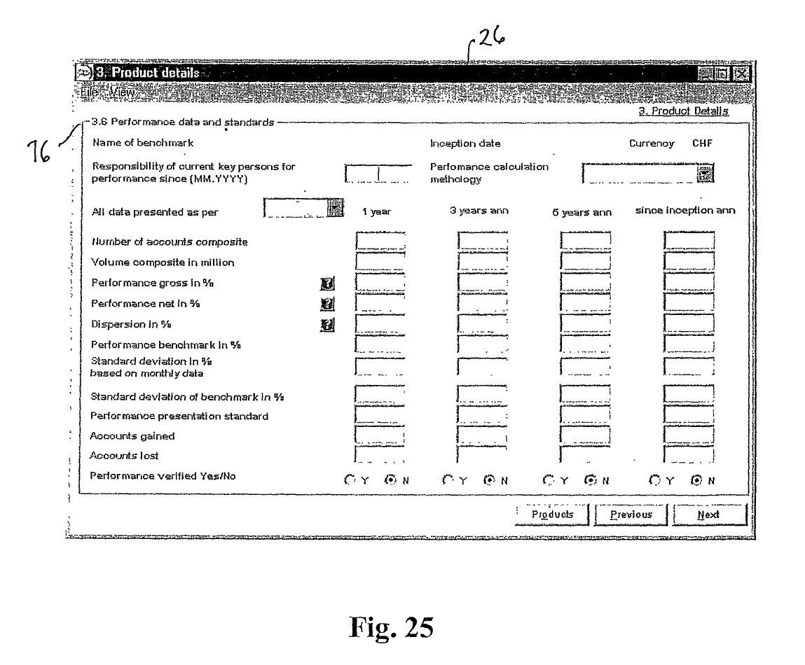

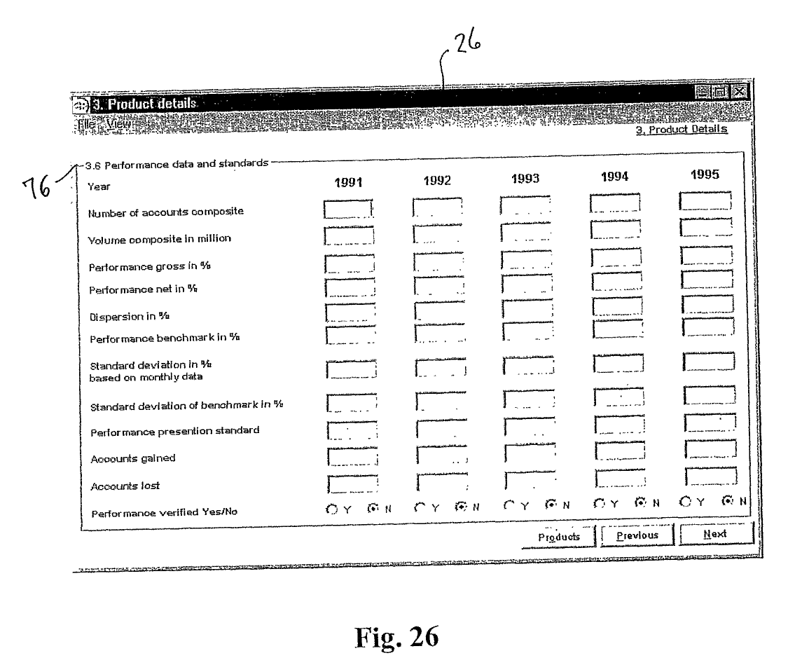

In FIGS. 10-13, the manager may enter data relating to types of investment products the manager manages, such as flagship products 46 (which are also referred to as “traditional products,” such as equity, bonds, convertible bonds, and the like, shown in FIGS. 10-12) and alternative products 48 (which are also referred to as “non-traditional products” such as hedge funds, private equity and the like, shown in FIG. 13). In FIGS. 14-29, the manager may enter data on the details of the products managed by the asset manager, including but not limited to basic product information 50 (FIG. 14), product specification 52 (FIG. 15), assets under management 54 and responsible portfolio manager 55 (FIG. 16), account size and cost 56 (FIG. 17), investment team 58 (FIG. 18), investment philosophy 60 (FIGS. 19-20), reference list 62 (FIG. 21), management style 64 and decision factors 66 (FIG. 22), actively steered parameters 68 and approach for passive products 70 (FIG. 23), expected results 72 and historic results 74 (FIG. 24), and performance data and standards 76 (FIGS. 25-29). Passive products are those products whose goal to mirror the performance of a certain benchmark, such as the S&P 500. Active products are products whose goal is to outperform a certain benchmark.

Once data is saved and the manager accesses the system of the present invention on another occasion, the manager does not need to repeatedly enter the same data, as it has already been saved in the data storage file.

Referring back to FIG. 2, for uploading questionnaire data, the manager clicks in the upload button 20, whereupon the manager is prompted to identify the location of the data storage file. Once identified, the data stored in the data storage file is uploaded to and stored in the database 78 via the network 11 from the manager's computer 13, shown in FIG. 30. Preferably, the database 78 uses Oracle software, and the data is uploaded to and stored in the database via standard query language (SQL), although other software and data storage methods may be used in alternative embodiments. Once in the database 78, the data is categorized and sorted with respect to data submitted by other asset managers for later retrieval, wherein reports may be generated for investors and managers according to any data field of the questionnaire.

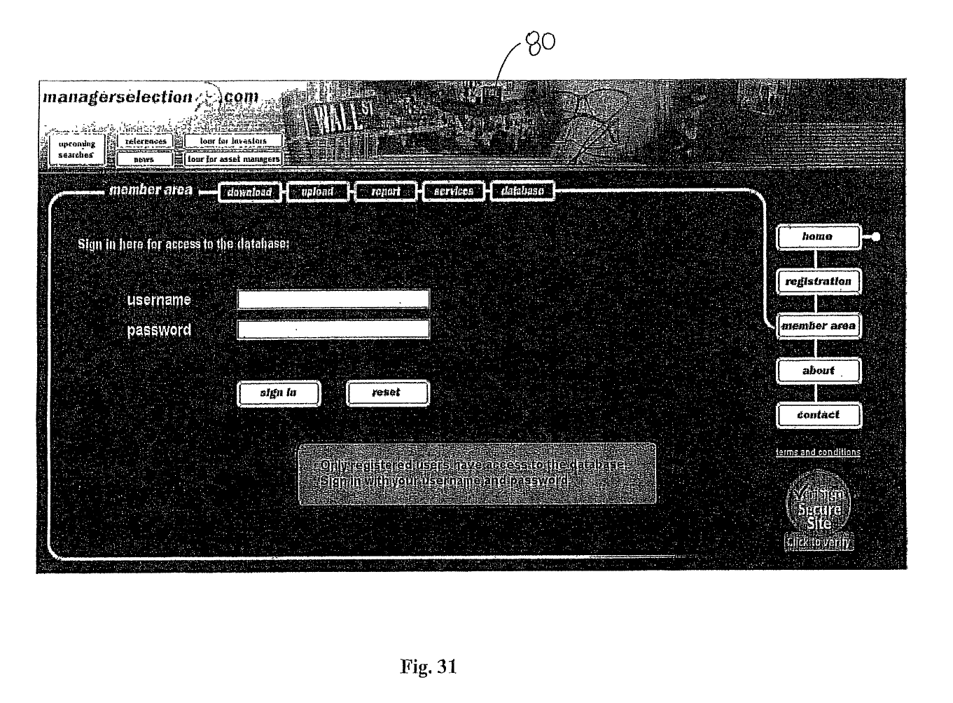

By accessing the database 78, the manager may generate a manager report to see how his or her organization or products compare to those of other asset managers. As shown in FIG. 2, to access the database 78 and generate a report, the manager clicks on the database button 24. Thereafter, as shown in FIG. 31, the manager is presented with database access login screen 80 and is prompted to enter a username and password. If the login is unsuccessful, an error message is returned.

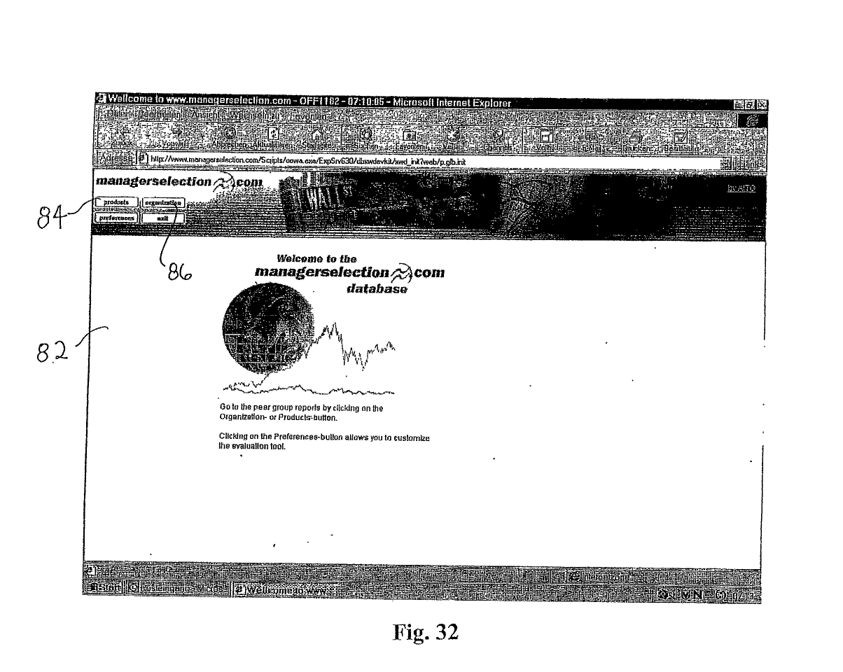

If the login is successful, as shown in FIG. 32, the manager is presented with a database welcome page 82, wherein a manager may generate peer group reports comparing a full range of each submitted product with similar products of other asset managers (i.e, the applicable universe). The peer group analysis of the present invention allows asset managers to receive detailed feedback on the position of products submitted by each asset manager within the applicable universe. The report may contain comparisons of the organizational structure of the asset managers in their respective universes, comparisons of realized performances of products in similar respective categories, comparisons of risk measures, fees, type of performance (composite, certified, etc.) and the like.

The database welcome screen 82 contains two buttons for generating two different types of peer group reports: a products button 84 and a organization button 86. If the manager selects the organization button 86, the manager is able to generate peer group reports relating to organizations competing with the manager for similar product universes. These peer group reports provide analyses on the organizations of all the asset managers in the database, as well as analysis of various product data. Product data is always compared to the respective universes of the products submitted to the database by the asset manger.

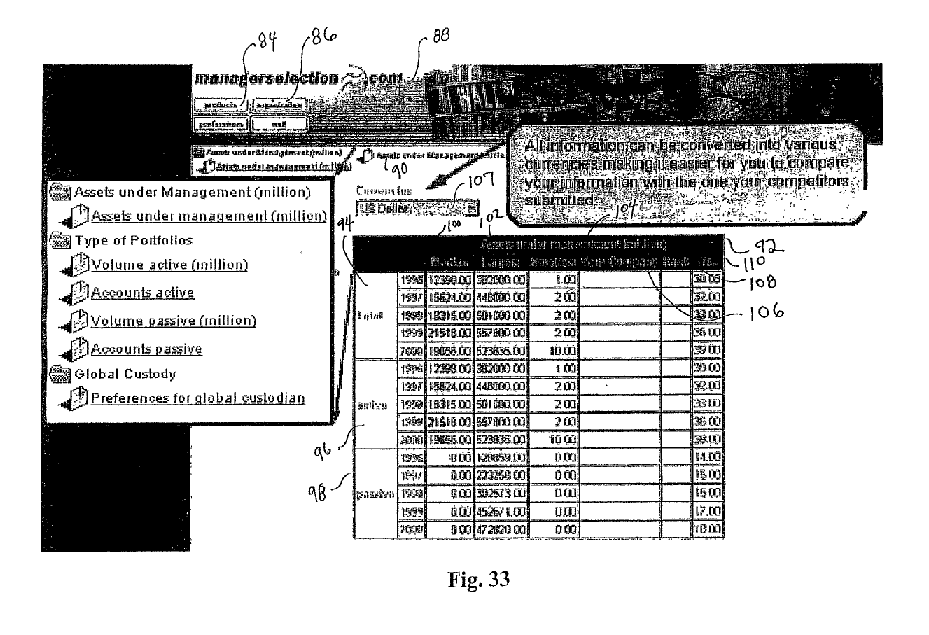

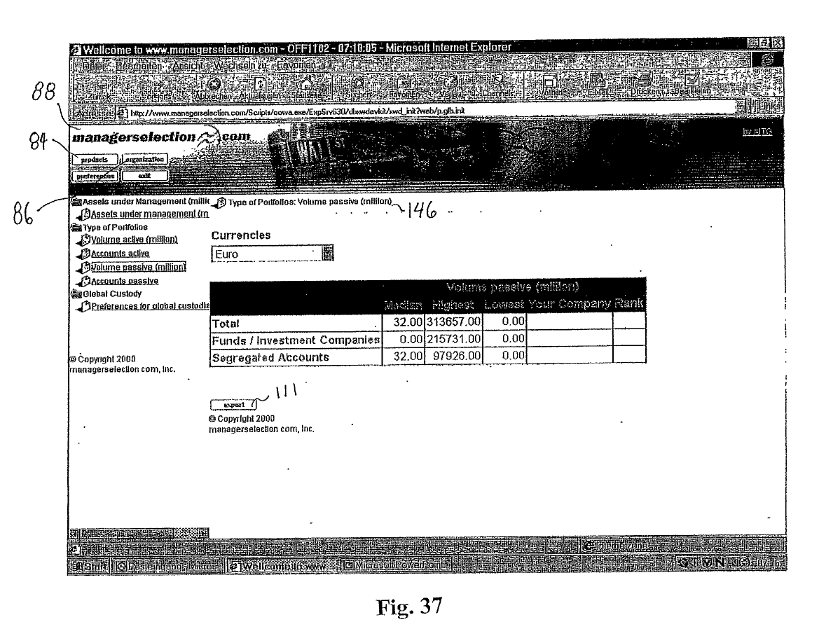

One organizational peer group report 88 reporting assets under management (in millions) 90 is shown in FIG. 33. A table 92 displays information relating to total assets 94, active assets 96 and passive assets 98. The table 92 also includes historical data on the median 100, largest 102 and smallest 104 asset values of competing organizations, as well as the manager's own company 106 and rank 108. The column on the right 110 when viewing FIG. 33 shows the number of data points, i.e., the number of organizations reporting data for each row of data. Additionally, in all reports, a pull-down menu 107 allows the manager to convert currency data of one country into data of another country's currency. Further, all peer group reports may be exported to a spreadsheet program, such as Microsoft Excel, by clicking on an export button 111, shown e.g., in FIGS. 37-39, whereupon further analysis may be performed.

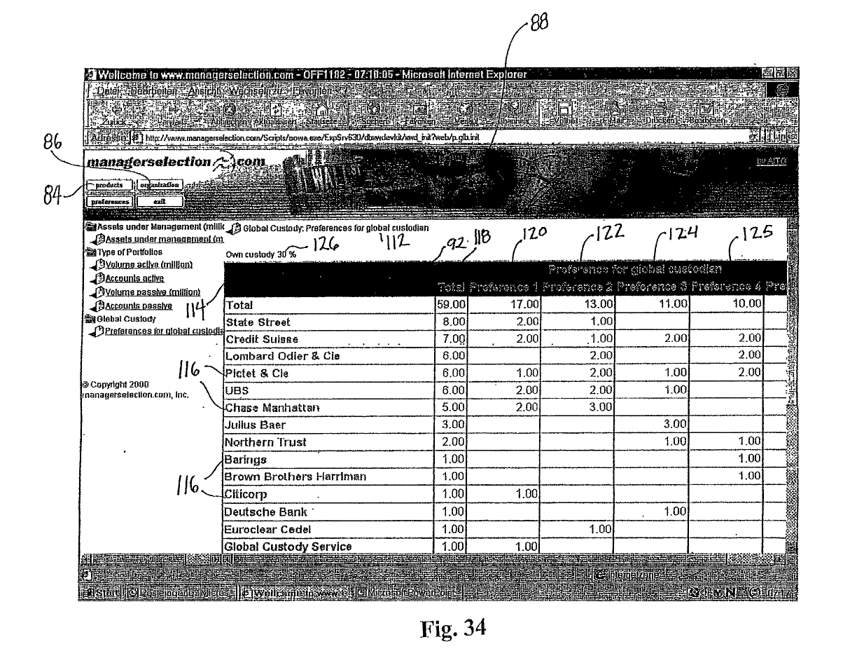

Another such organizational peer group report 88 reporting manager preferences for a product custodian 112 is shown in FIG. 34. A product custodian is defined as the financial institution having physical possession of the asset. A table 92 displays a column 114 having data displaying a variety of product custodians 116. Other columns display total number of managers selecting each product custodian 118, as well as a plurality of preference rankings 120, 122, 124, 125. For example, a total of five asset managers selected Chase Manhattan Bank as a preferred product custodian 116. Of these five, two asset managers ranked Chase Manhattan Bank as its No. 1 preferred product custodian, while three asset managers ranked it as its No. 2 product custodian. Such information is displayed for each row of product custodians. Additionally, the number of asset managers offering in-house custody services is displayed at 126.

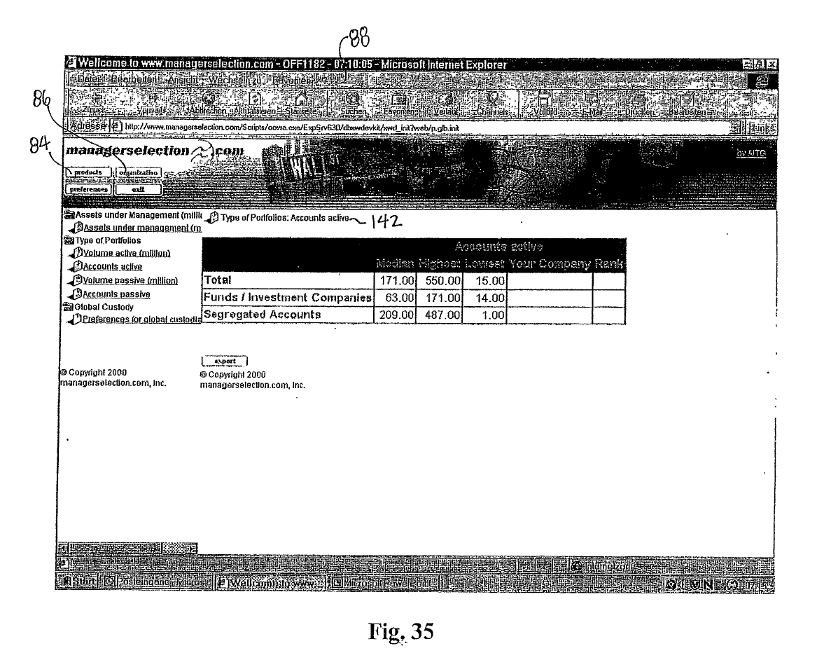

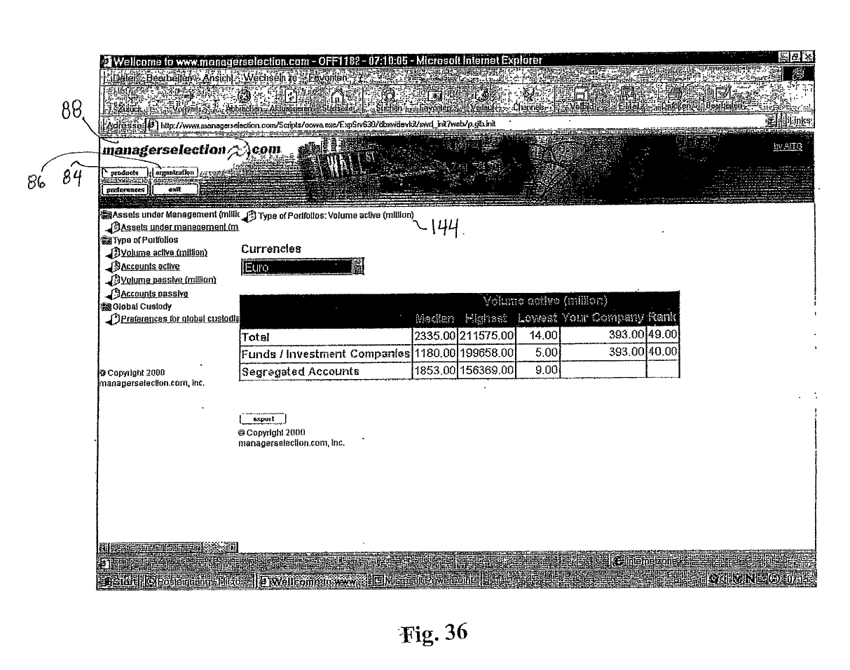

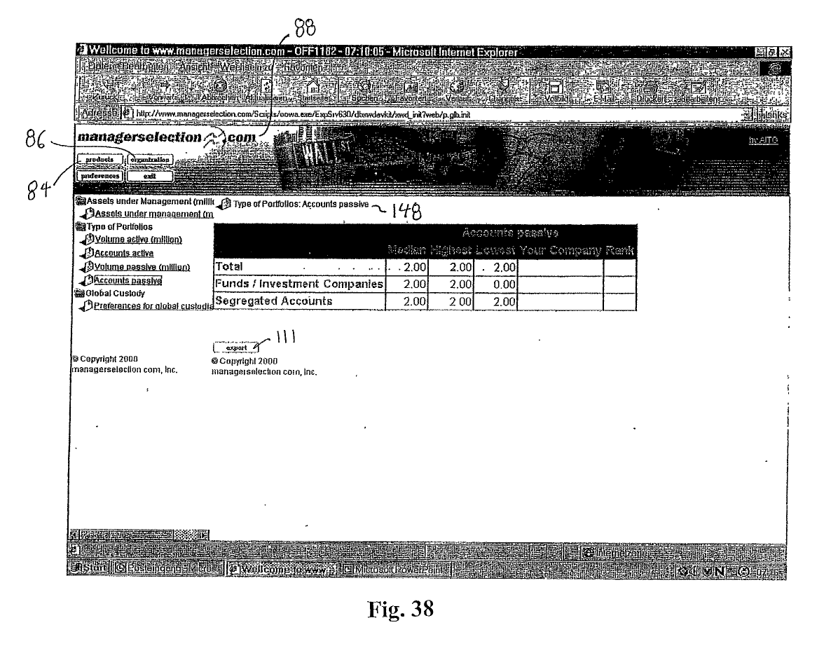

Other types of organizational reports include, but are not limited to: number of accounts active 142, shown in FIG. 35; active portfolio volume 144, shown in FIG. 36; passive portfolio volume 146, shown in FIG. 37; and number of passive accounts 148, shown in FIG. 38.

If the manager selects the products button 84, as seen in FIG. 32, the manager is able to generate manager peer group reports showing how products submitted by the manager to the database 78 compare to similar products (i.e., products in the same main and subcategory) offered by other managers.

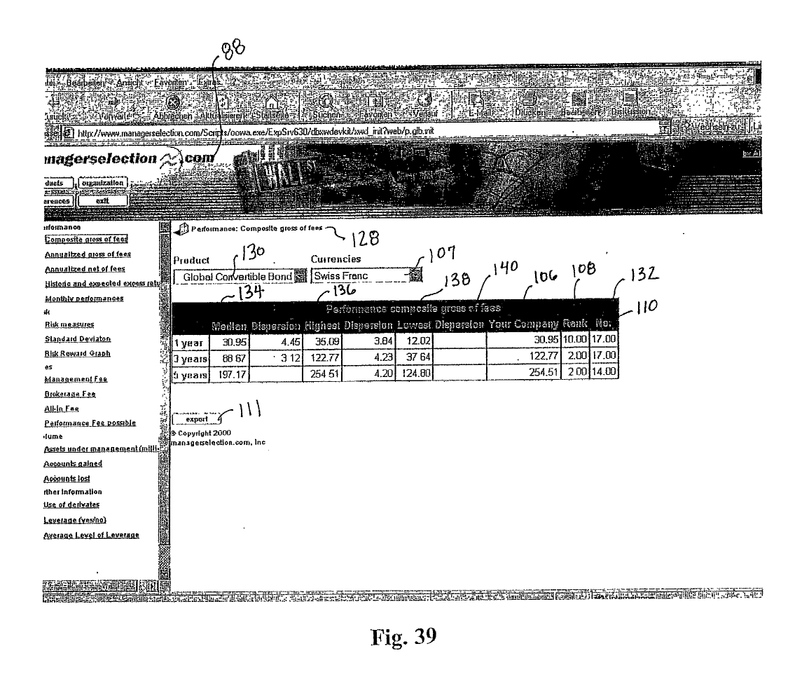

FIG. 39 shows a such product peer group report 88 showing historical data relating to performance: composite gross of fees 128. The category and subcategory for the product (shown as Global Convertible Bond) is shown in a pull-down menu 130, along with the pull-down currency menu 107 are shown in the report, and may be easily modified by changing the selection in the pull-down menu. Also shown is a table 132 displaying information relating to median 134, highest 136 and lowest 138 composite grosses of fees, together with the associated dispersion 140, as well as the manager's own company 106, rank 108, including the number of data points 110.

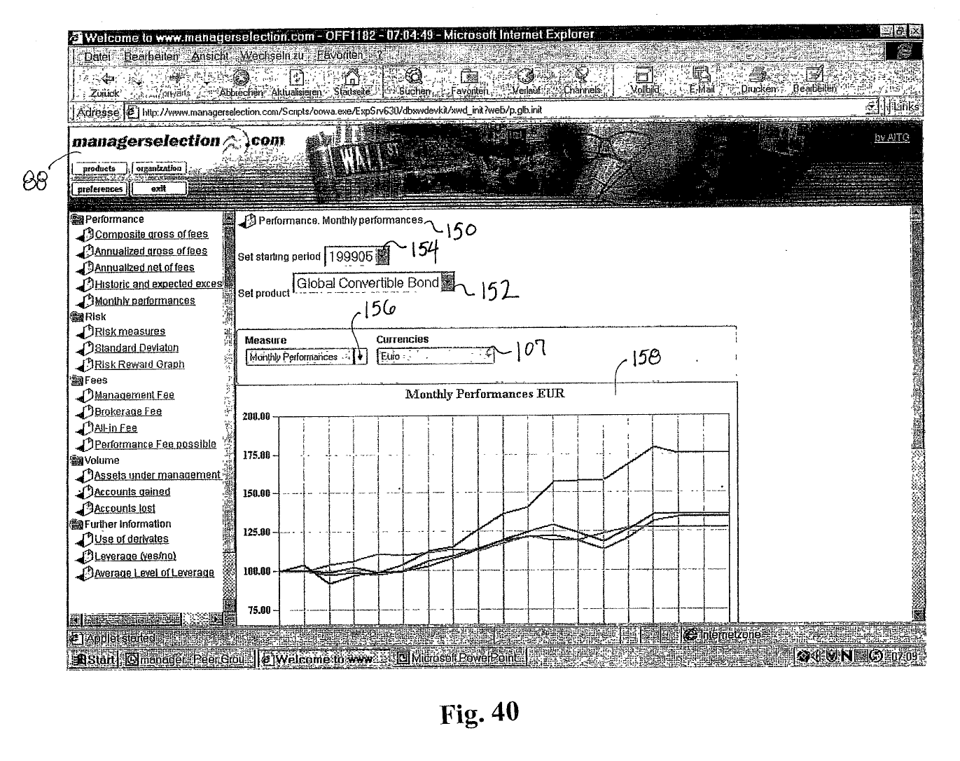

FIG. 40 shows another such peer group report 88 showing performance: monthly performances 150. The product (shown as Global Convertible Bond) may be set by pull-down menu 152, and a starting period (shown as May, 1995) for evaluation 154 may be set by another pull down menu 154. Additionally, the unit of time (shown as monthly) to be measured may be set by a pull-down menu 156, and the currency may be set by pull-down menu 107. Once the pull down menus 107, 152, 154, 156 have been set, a graph 158 showing the asset manager's performance with respect to that of other asset managers, in different colors. Performance is plotted along the Y-axis, with respect to time, which is plotted along the X-axis. By generating such a report, the manager may evaluate, for example, all of the manager's products over varying time periods and how the manager performed in comparison with other managers in the same field.

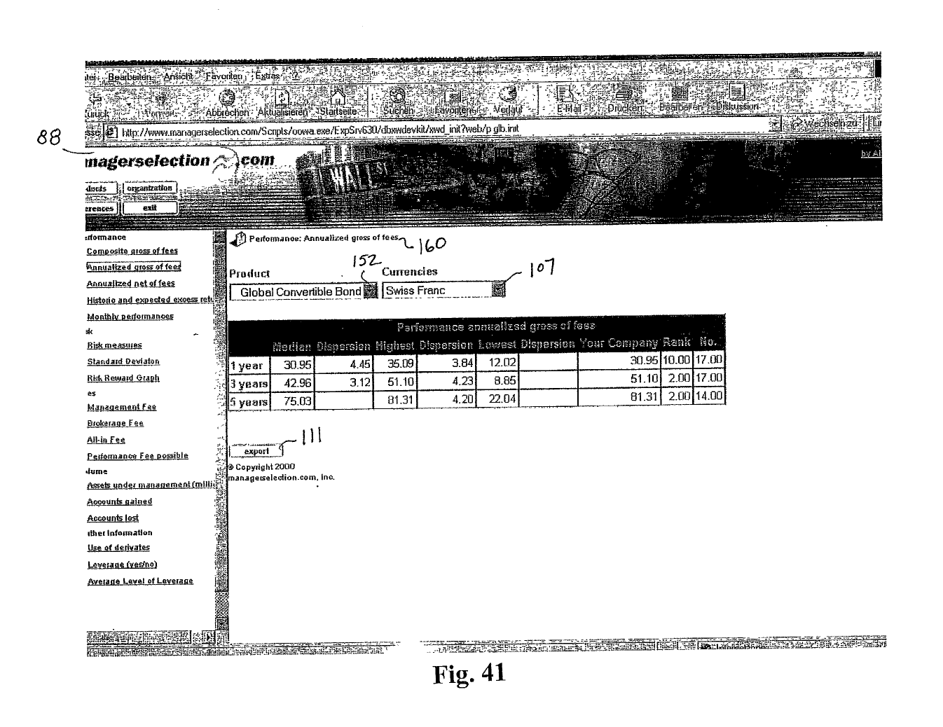

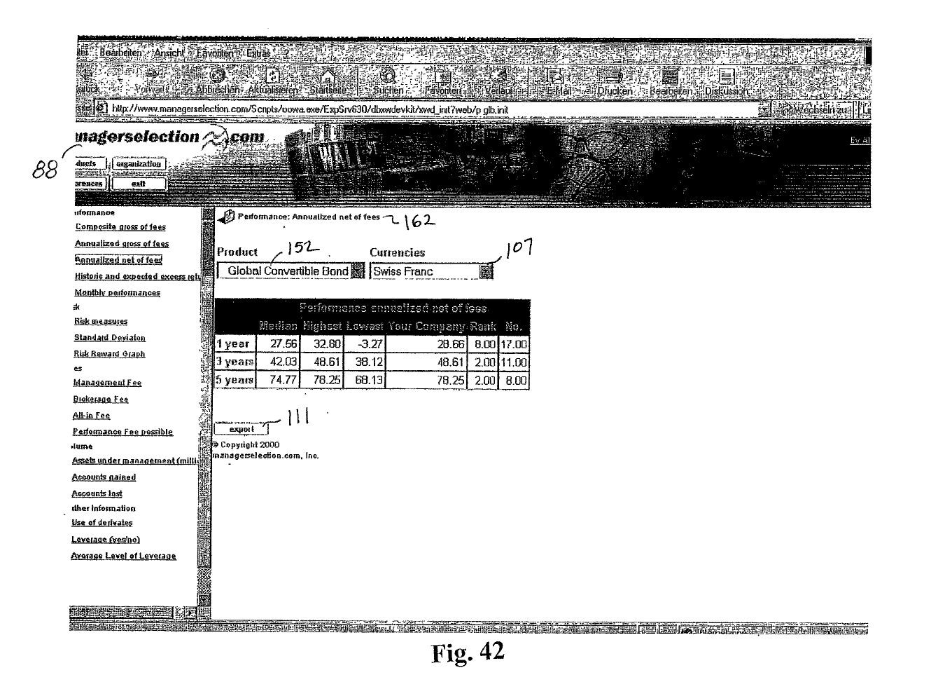

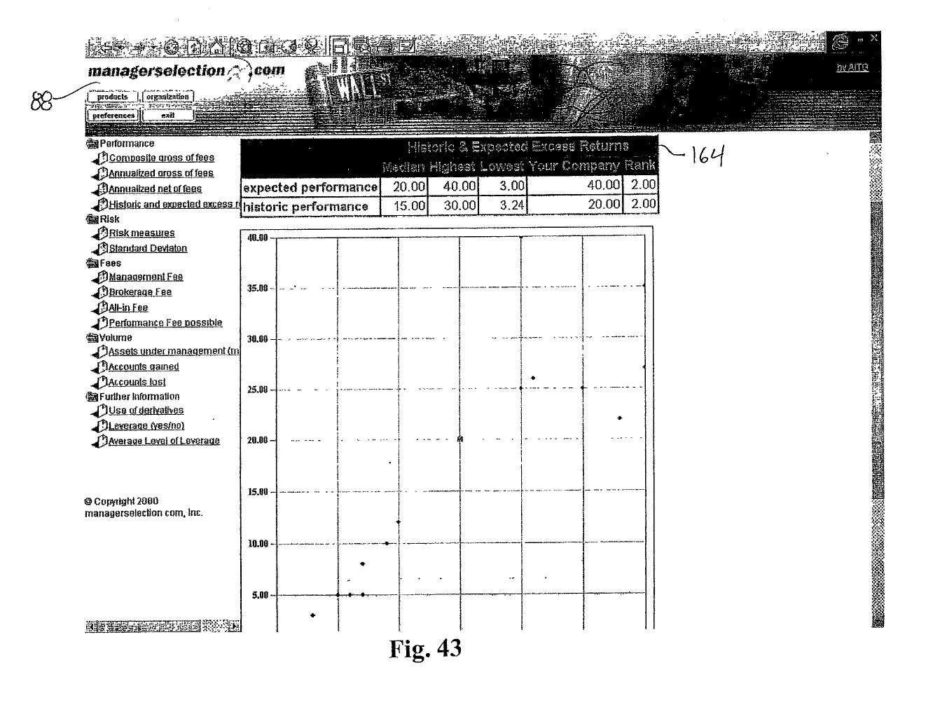

Other product performance reports include, but are not limited to: annualized gross of fees 160, shown in FIG. 41; annualized net of fees 162, shown in FIG. 42; historic and expected excess returns 164, shown as a table in FIG. 43; and historic gross of fees (not shown).

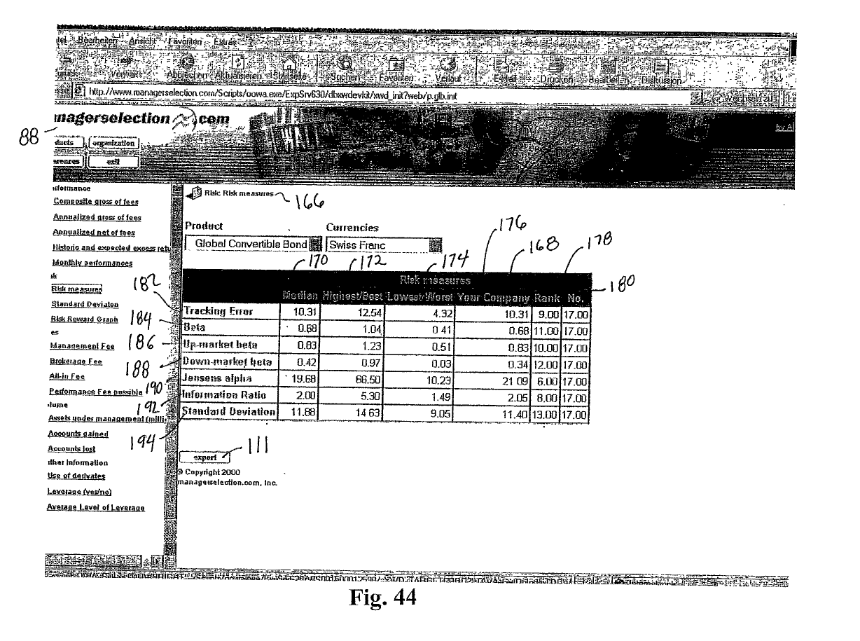

The manager may also generate reports 88 relating to risk factors. One such risk factor report relates to risk: risk measures 166 and is shown in FIG. 44. A risk measure table 168 contains data relating to risk measures with respect to the median value 170, highest/best 172 and lowest/worst 174 of all participating asset managers, as well as the asset manager's own company's position 176, rank 178, including the number of data points 180. Rows of risk measuring data categories are tracking error 182, beta 184, up-market beta 186, down-market beta 188, Jensens alpha 190, information ration 192 and standard deviation 194.

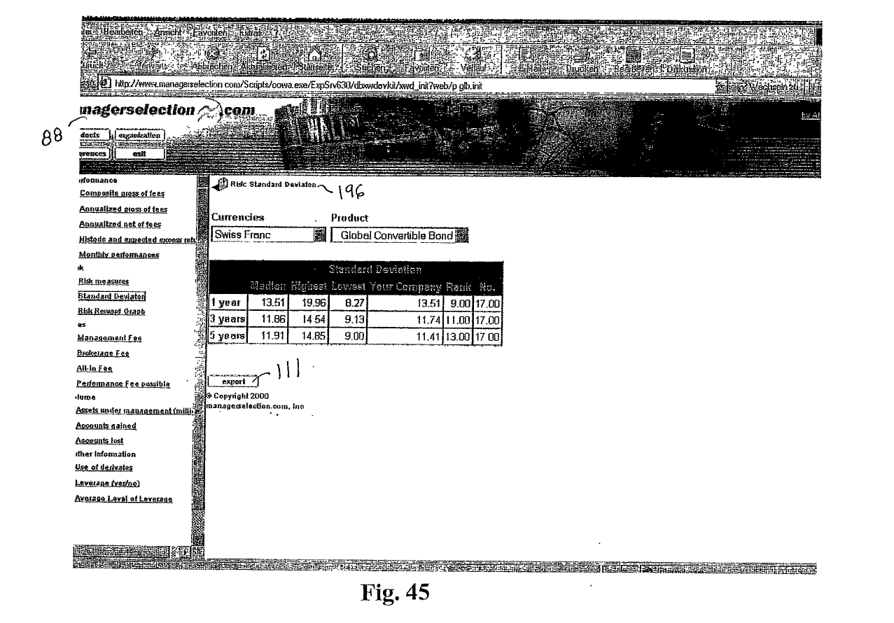

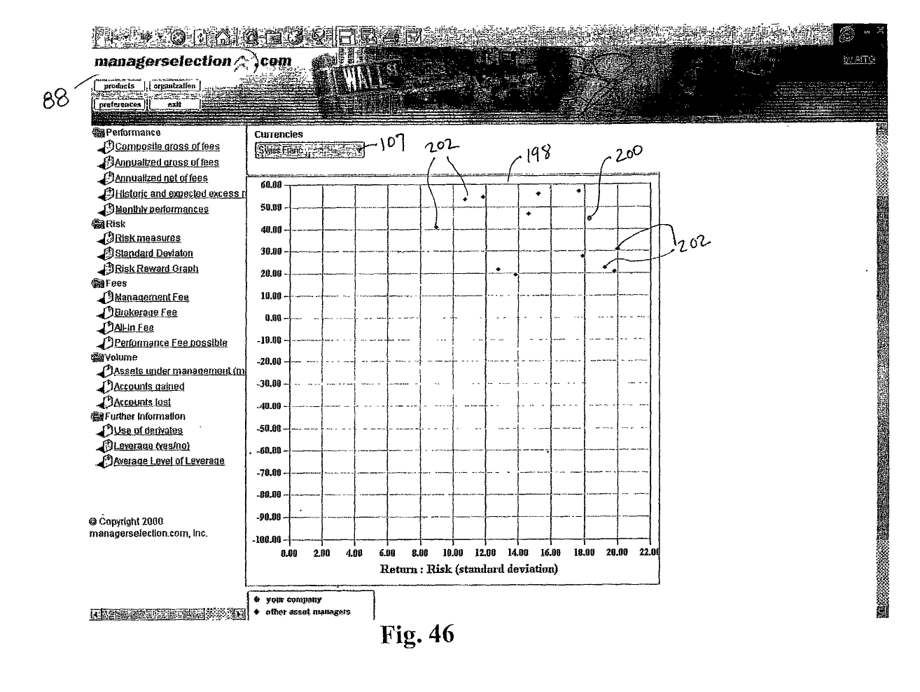

Information relating to historical standard deviation 196 is shown in FIG. 45, and a risk-reward graph 198 is shown in FIG. 46. The risk-reward graph 198 details the performance of an individual asset manager with other asset managers with respect to selected product and currency. The risk-reward graph 198 shows the managers own performance with a single identifying mark 200, and the risk-reward performance of other asset managers is shown with distinguishing identifying marks 202 distinctive from the single identifying mark.

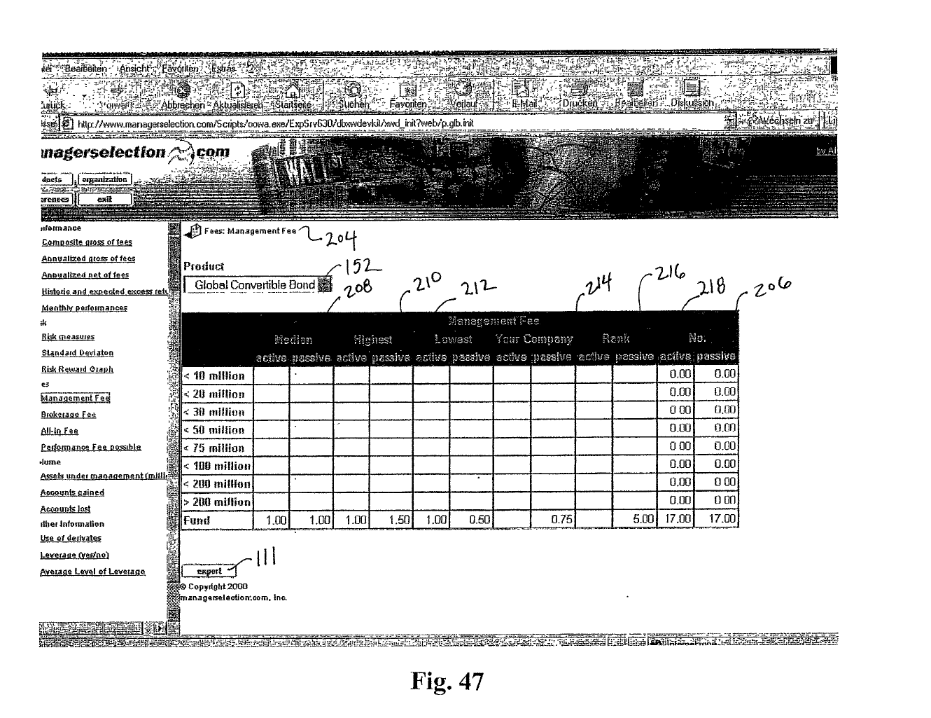

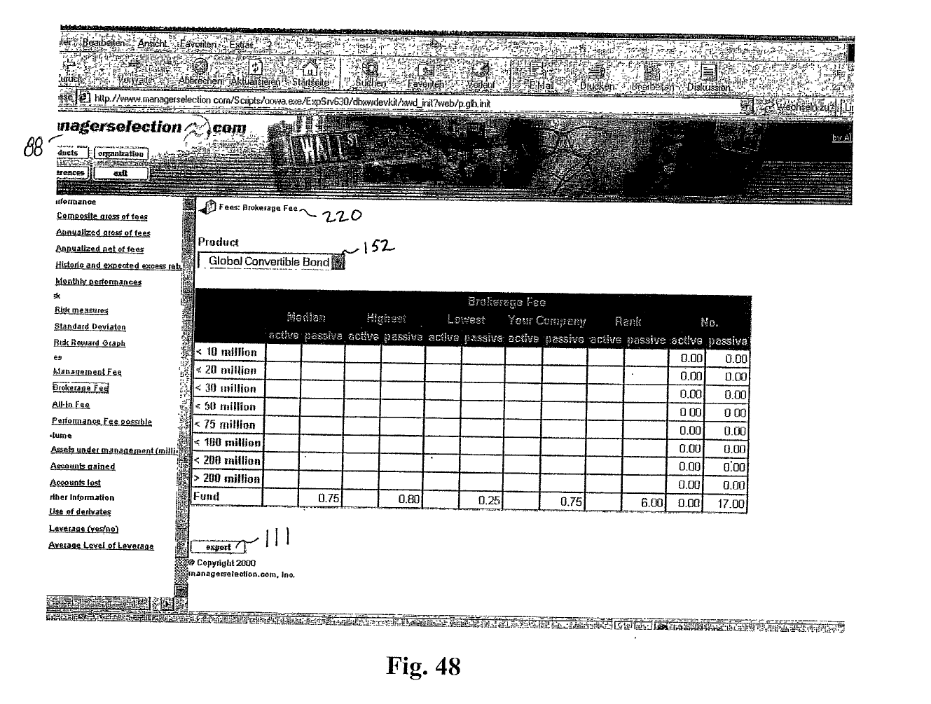

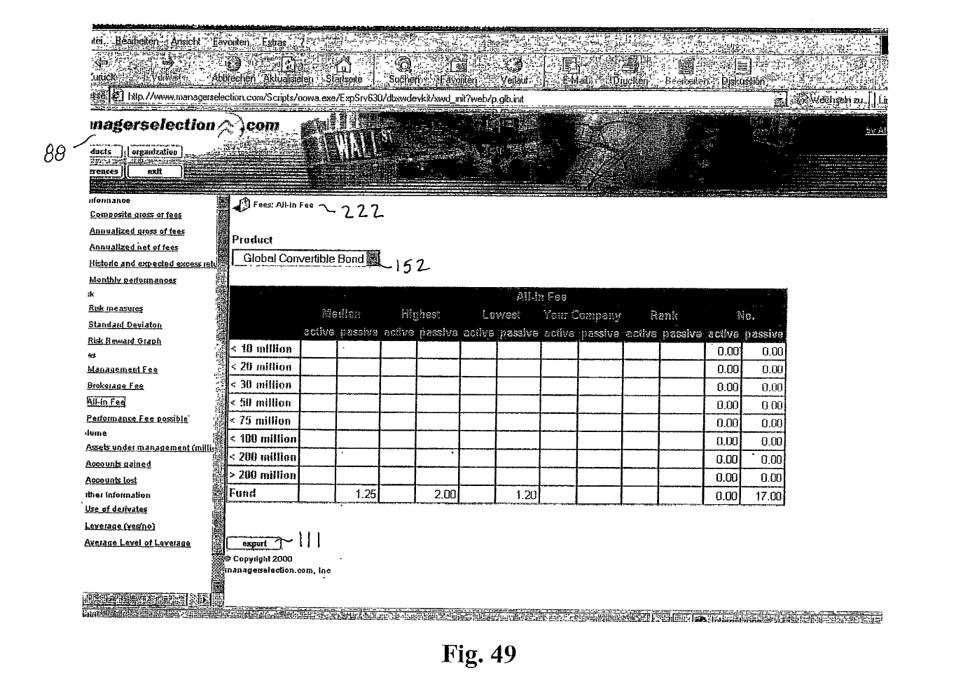

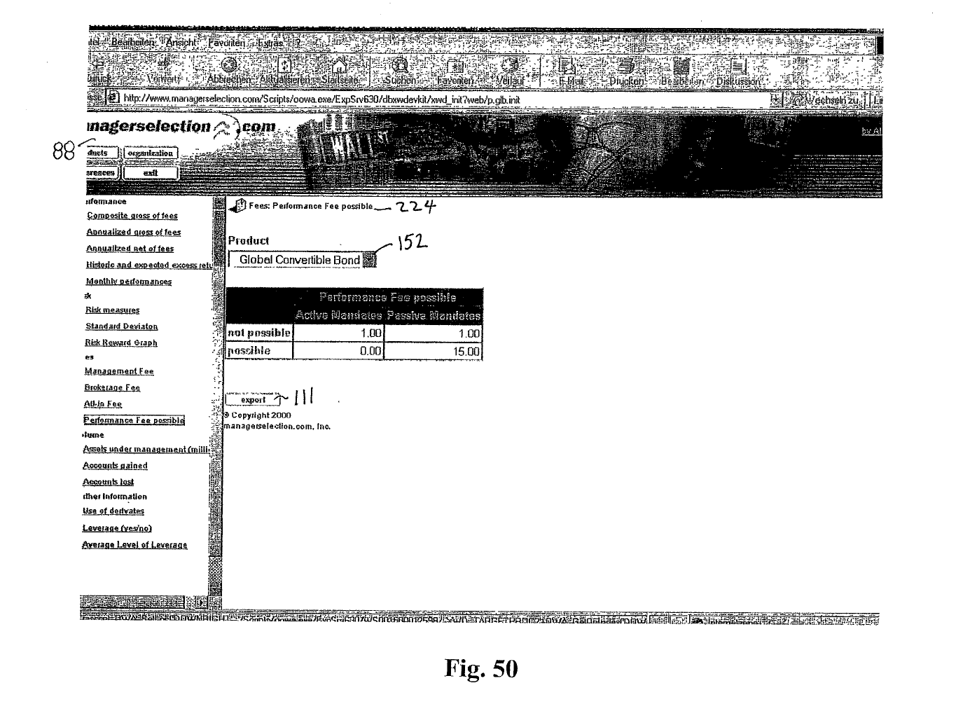

The manager may also generate reports 88 relating to fees. One such fee report relates to fees: management fee 204, shown in FIG. 47. The management fee report is product-specific, and shows a management fee table 206 contains data relating to management fees (in percentage of total value of the assets) with respect to the median value 208, highest 210 and lowest 212 of all participating asset managers, as well as the asset manager's own company's position 214, rank 216, including the number of data points 218. Data are further broken down with respect to whether the product is passive or active. Rows of categories indicate the value of assets managed. Other fee reports include, but are not limited to: brokerage fee 220, shown in FIG. 48; all-inclusive fee 222, shown in FIG. 49; and whether a performance-based fee 224 is available and the amount of the same, shown in FIG. 50.

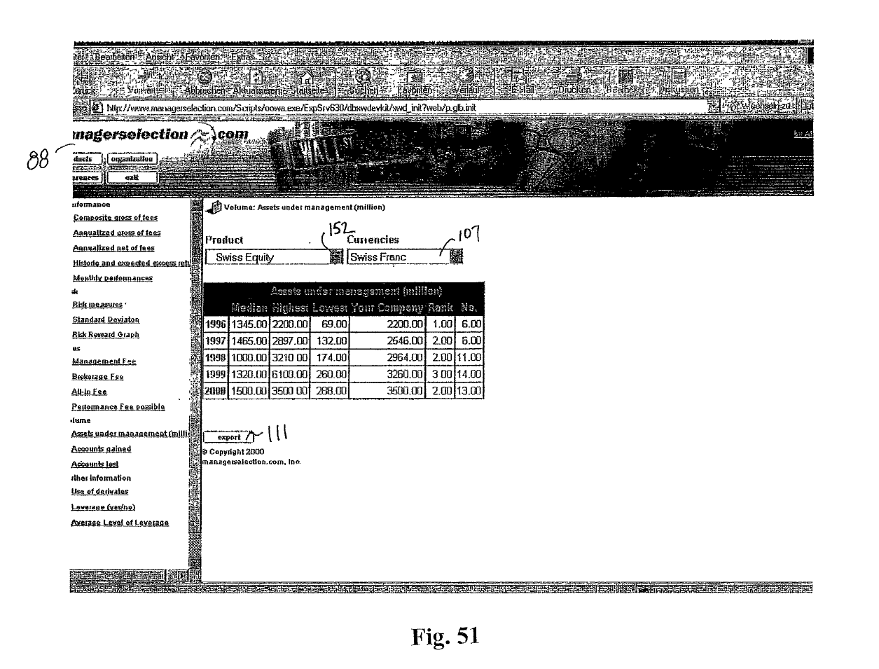

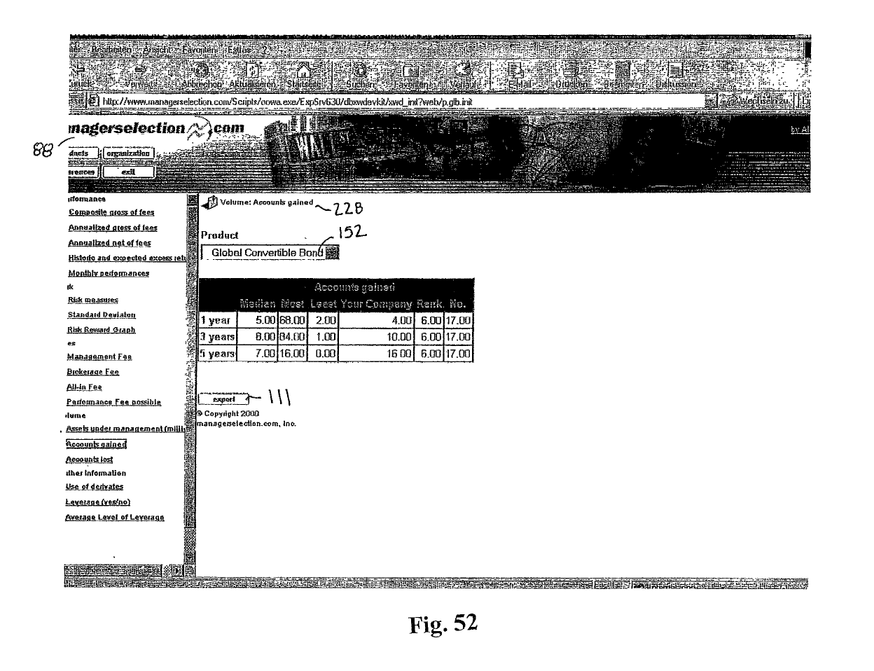

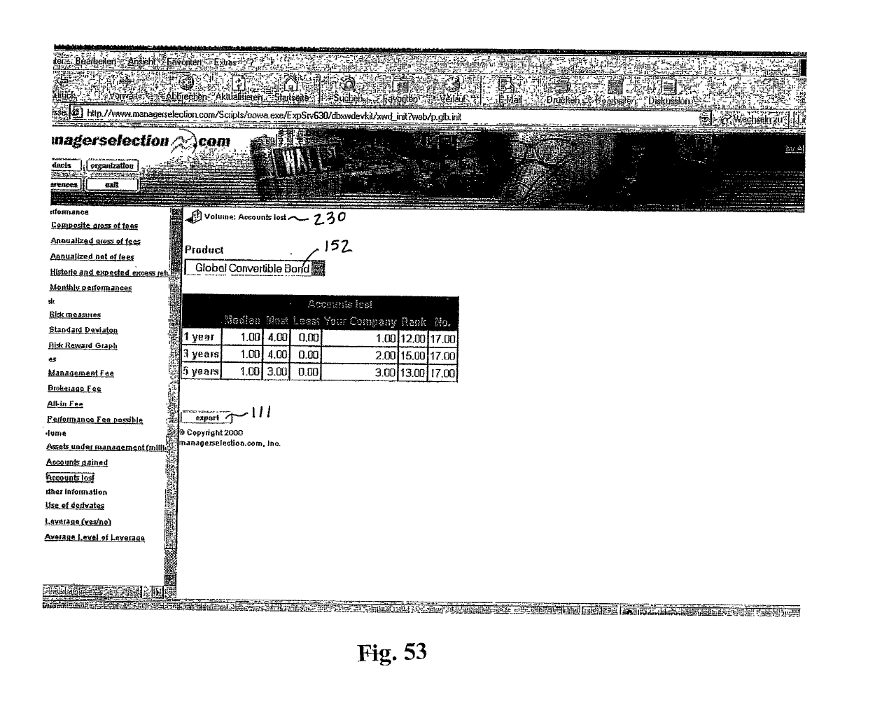

The manager may further generate reports 88 relating to product volume, such as assets under management 226, shown in FIG. 51; number of accounts gained 228, shown in FIG. 52; number of accounts lost 230, shown in FIG. 53.

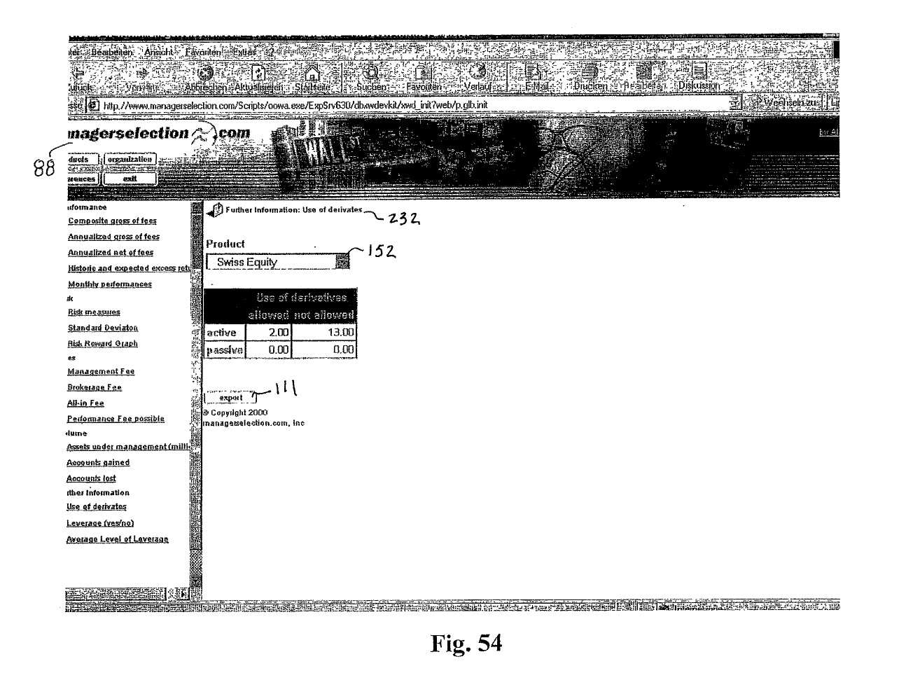

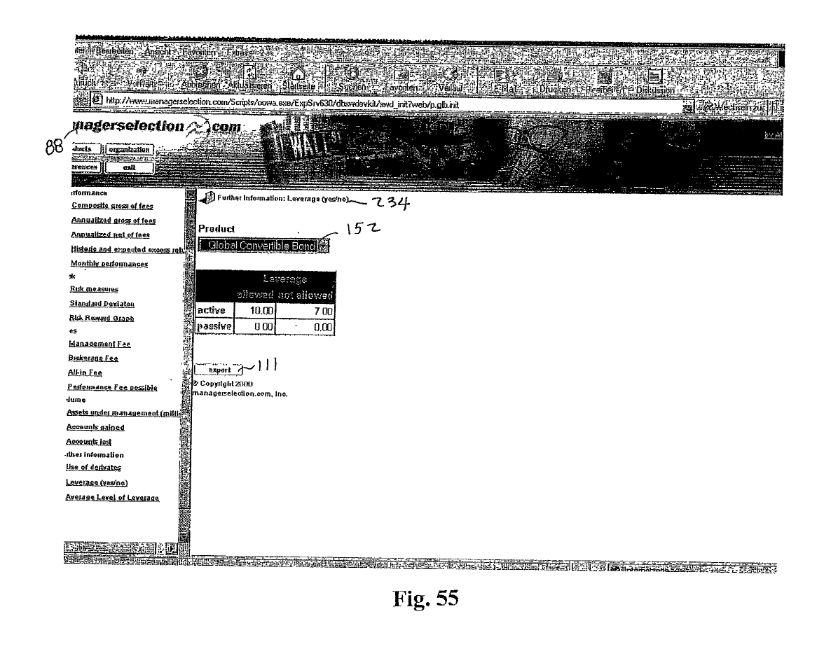

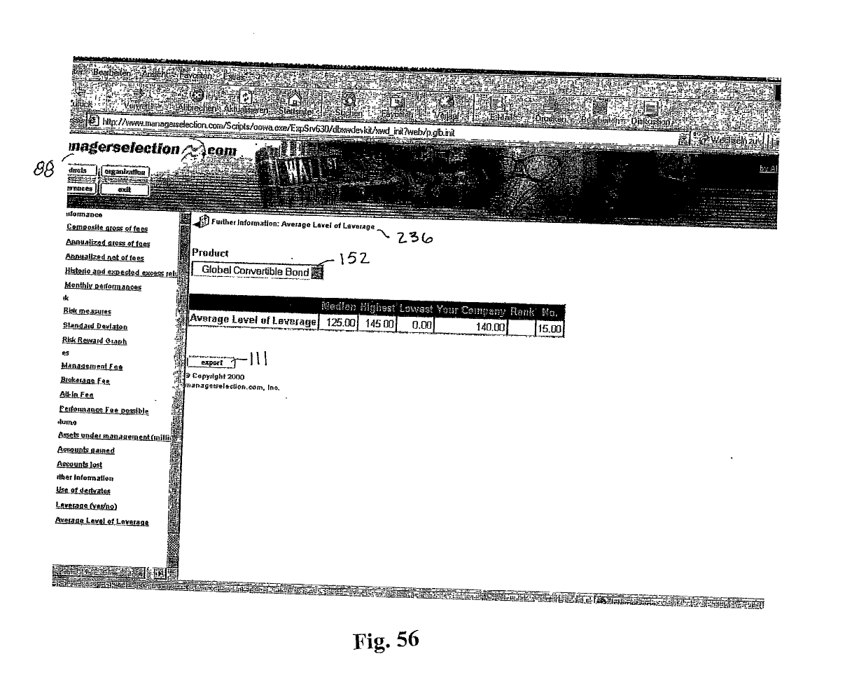

Other types of peer-group reports 88 relate to indicating whether or not a manager uses derivatives 232, shown in FIG. 54; whether or not leverage is allowed 234, shown in FIG. 55; and the average level of leverage 236, shown in FIG. 56.

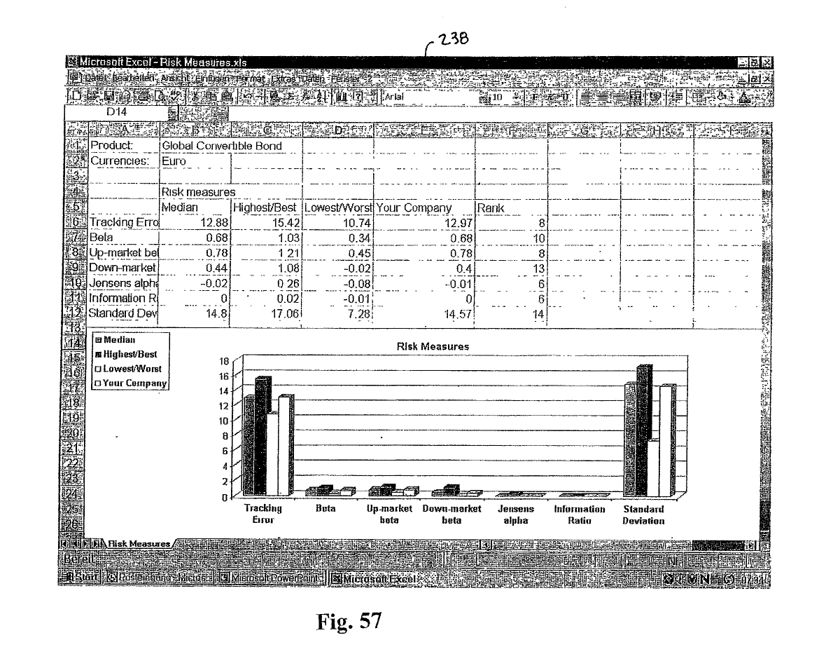

As discussed above, all peer group reports 88 may be exported to a spreadsheet program, such as Microsoft Excel, by clicking on the export button 111, shown e.g., in FIGS. 37-39, whereupon further analysis may be performed. One such exported report spreadsheet 268 is shown in FIG. 57. This exported spreadsheet 268 details the risk measures 166 exported from the report 88 shown in FIG. 44.

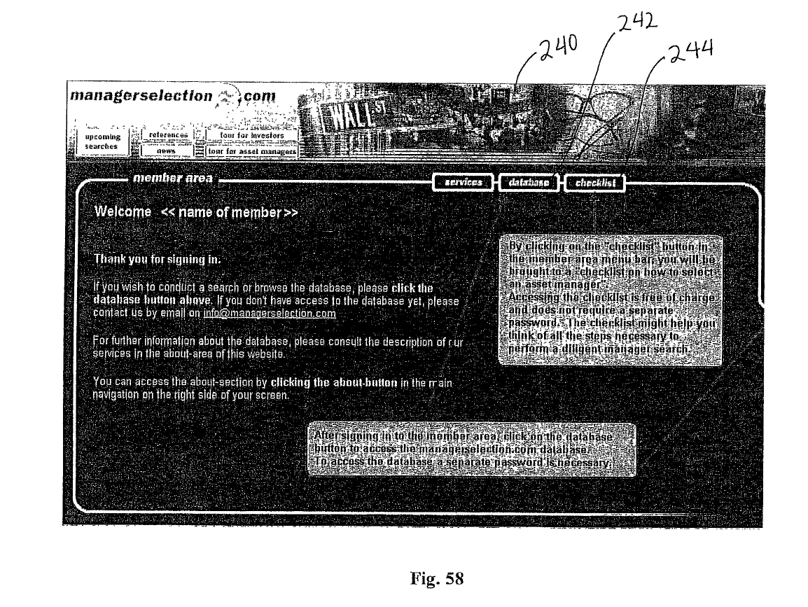

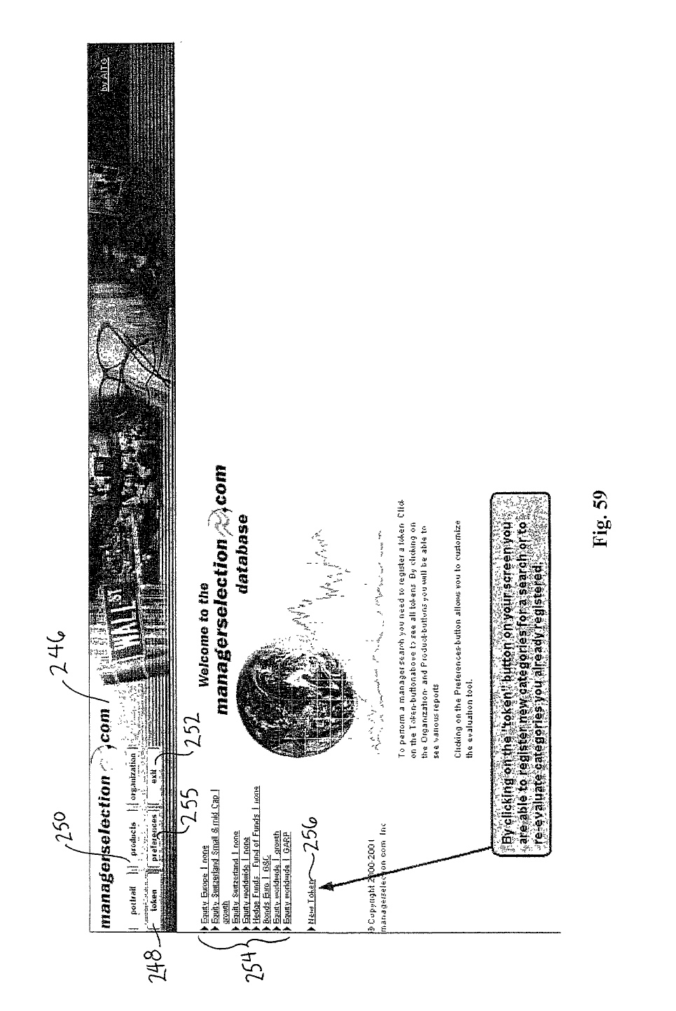

If the operator is an investor, the investor is presented with the investor/consultant, or investor, welcome page, shown as 240 in FIG. 58, wherein a variety of buttons are presented, including database 242 and checklist 244 buttons. If the investor clicks on the checklist button 244, the investor is brought to a page (not shown) showing a checklist providing information on how to select an asset manager. If the investor clicks on the database button 242, the investor is brought to an investor member area page, shown as 246 in FIG. 59, wherein a variety of buttons are presented, including token 248, products 255 and exit 252.

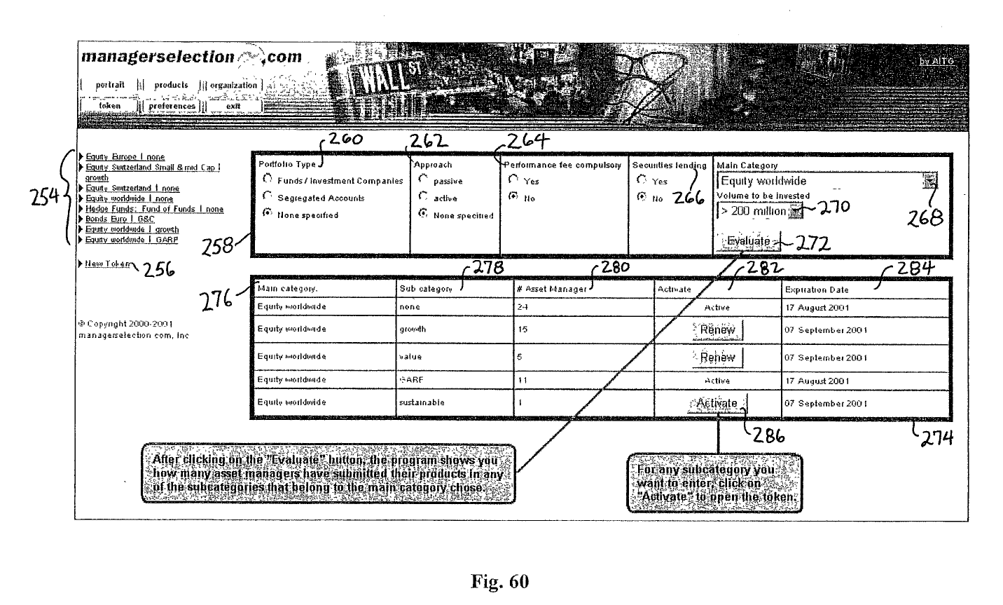

If an investor clicks on the token button 248, the investor is shown a list 254 of previously-registered searches, or “tokens.” If the investor desired to register a new token (i.e., perform a new search), the investor clicks on a new token link 256, whereupon the investor is taken to a search page 256, shown in FIG. 60. A new search table 258 including a variety of data fields including but not limited to: portfolio type 260, approach 262, performance fee 264, securities lending 266, main asset category 268, and volume to be invested 270, is shown on the search page 256. Other data fields may include investment style and presentation currency. Once the data fields 260-270 have been entered, the investor presses an “evaluate” button 272, whereupon the investor is shown the number of asset managers that have submitted products in any subcategories of the main category that the investor has entered. Once a token is registered for a specified category and subcategory, data entered in all fields may be changed when the token is retrieved at a later date, except the main category and subcategory fields. Generally, the only way a main category or subcategory may be changed is by registering a new token.

The search page 256 shows a matching search table 274, which shows rows of each subcategory of the main category that the investor has entered. The matching search table 274 includes data fields such as main category 276, subcategory 278, number of asset managers matching the search 280 (including total number and specific for each subcategory), active/inactive status 282, and expiration date 284. Generally, once a token is registered, is only valid for a finite number of days (e.g., 4 weeks). If a token is inactive (i.e., the investor has not proceeded with a narrowing search by providing additional search criteria), the investor may activate it and perform a narrower search by clicking on an “activate” button 286.

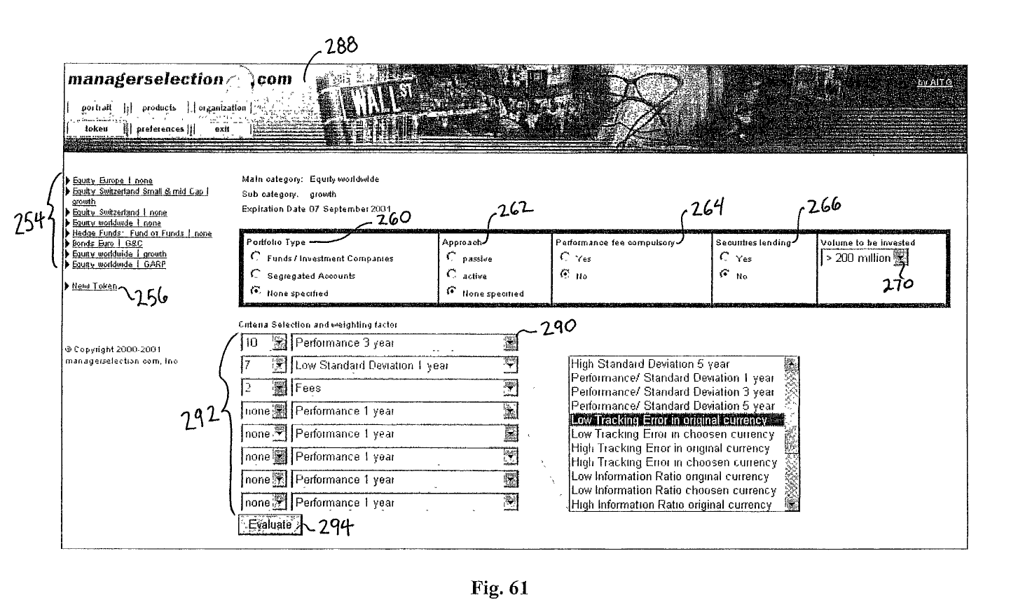

Once a search is activated, the investor is taken to an evaluation screen 288, shown in FIG. 61, whereupon the investor may narrow criteria used in selecting a manager by selecting fields from a pull-down menus 290, including, but not limited to, historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees.

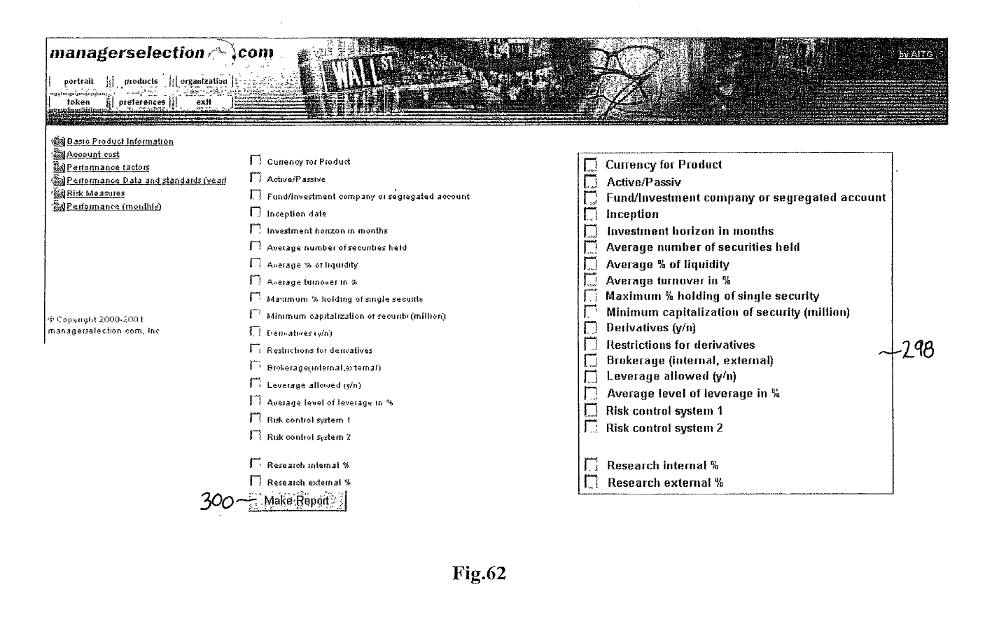

Additionally, the investor may weight the criteria by using a weighting system (e.g., a scale of 1 to 10), via pull down menus 292, so that the investor can place a greater or lesser emphasis on the criteria when selecting an asset manager. Once the various criteria are entered, the investor then clicks on an “evaluate” button 294, whereupon the investor is shown a products screen 296, shown in FIG. 62. In the products screen 296, the investor is presented with a variety of checkboxes 298, wherein the investor may check checkboxes 298 that correspond to factors the investor feels is important in making a decision on selecting an asset manager. Once the desired checkboxes have been checked, the investor may then generate an investor report based on data matched with data entered by asset managers, by clicking a “make report” button 300.

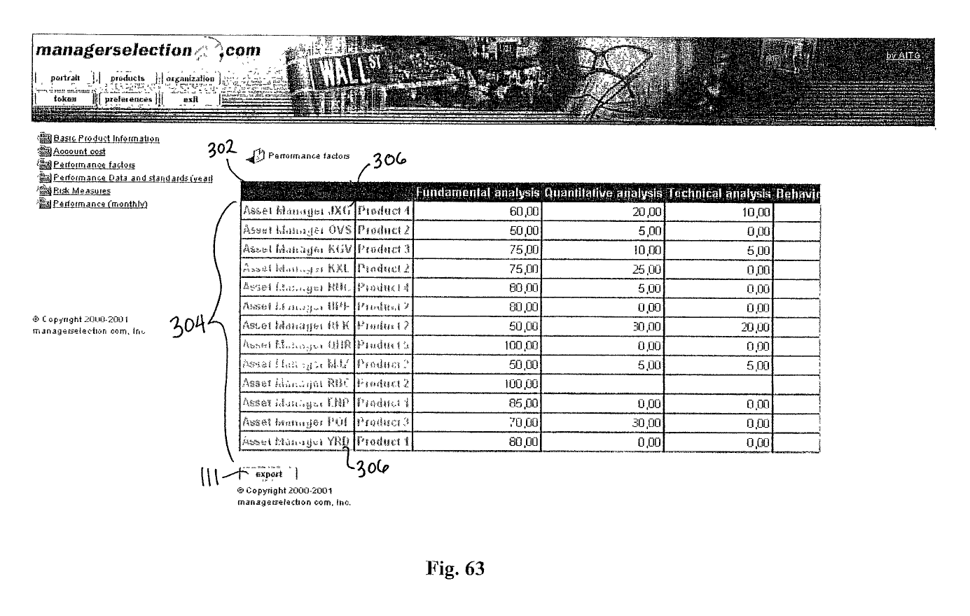

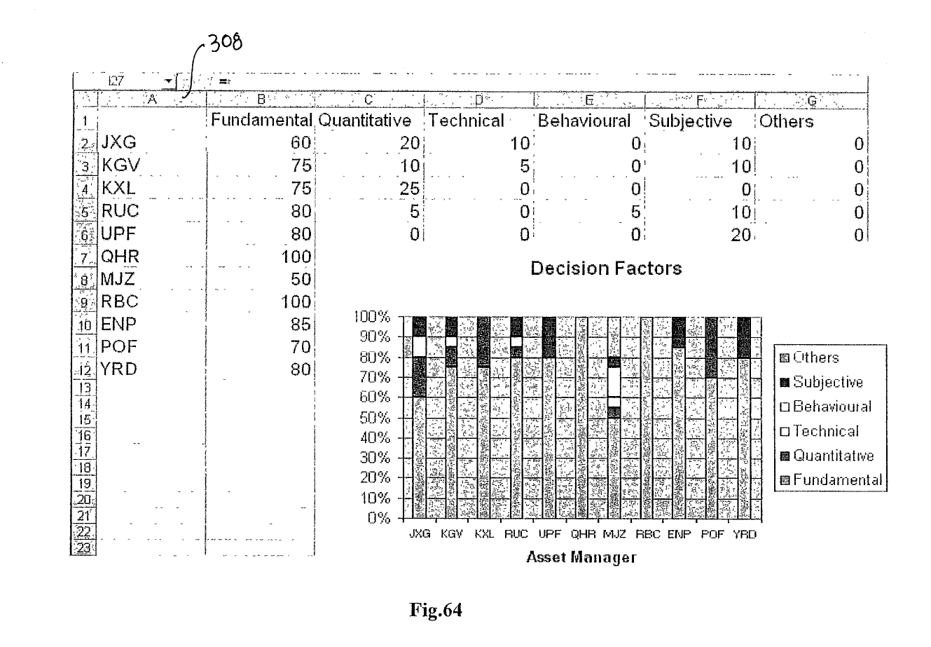

FIG. 63 shows a sample investor report 302 listing asset managers 304 that have matched the criteria entered by the investor for the desired product. The asset managers 304 are not identified by name, but are identified only by a code 306, to protect the privacy of the asset manager and to avoid any misuse of the asset managers' data. Thus, initially, the matching asset managers' identities are not disclosed, in order to prevent any name-biased pre-exclusion of asset managers. Further, the investor report allows the investor to analyze the factors taken into account during the management of the assets by the asset manager, such as fundamental, quantitative, technical, behavioral, and subjective. Additionally, as with the asset manager reports, discussed above, the investor report may be exported to a spreadsheet program 308, shown in FIG. 64, by clicking on the export button 111.

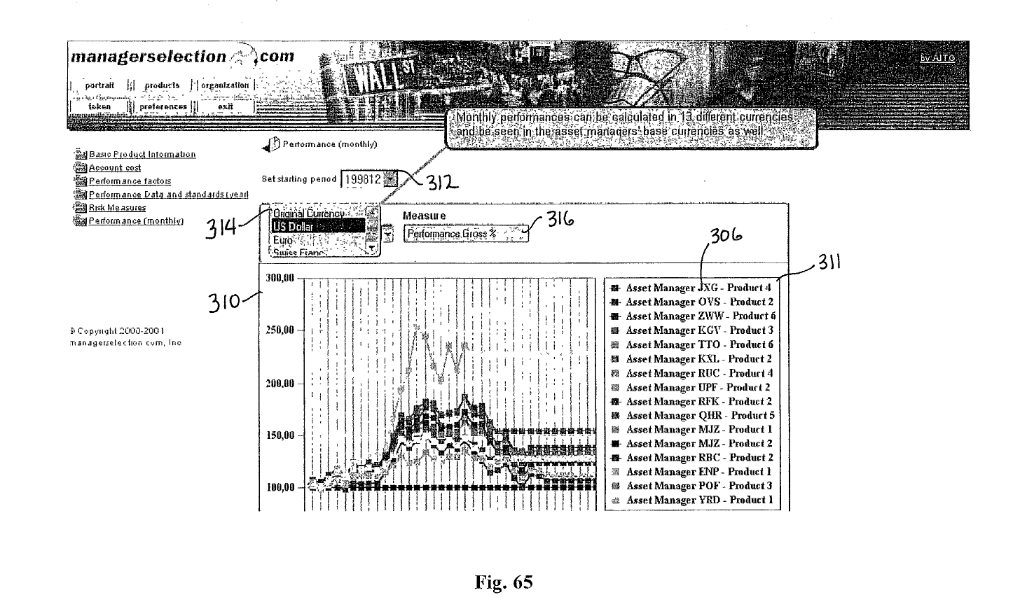

The investor report 302 may also be generated to show graphs and charts criteria listed by the investor. FIG. 65 shows a monthly performance graph 310 wherein monthly performance of asset managers 304, who are again identified by the code 306, is displayed with respect to the product type 311. The investor may, via a pull-down menu 312, set the starting period of the performance to be evaluated, and the investor may additionally select, via a menu 314, the currency in which the performance is to be evaluated, as well as the performance measure 316 (here, performance gross percentage) to be displayed. Further, performance graphs may be exported and downloaded by the investor for further analysis. Additionally, as with asset manager peer group reports 88, discussed above, investors may convert currency data of one country into data another country's currency.

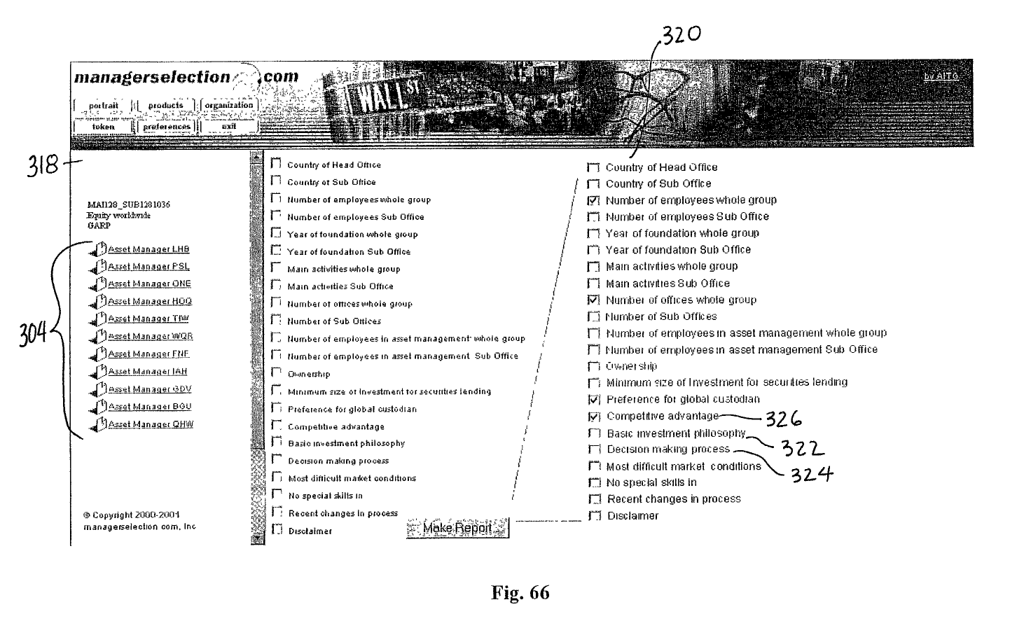

The investor report 302 also contains a portrait section 318, shown in FIG. 66, wherein the investor checks checkboxes 320 for providing portrait information on the asset managers 304 searched under the selected token, such as organizational structure and other data of each asset management house, including but not limited to investment philosophy 322, decision making process 324 and competitive advantage 326.

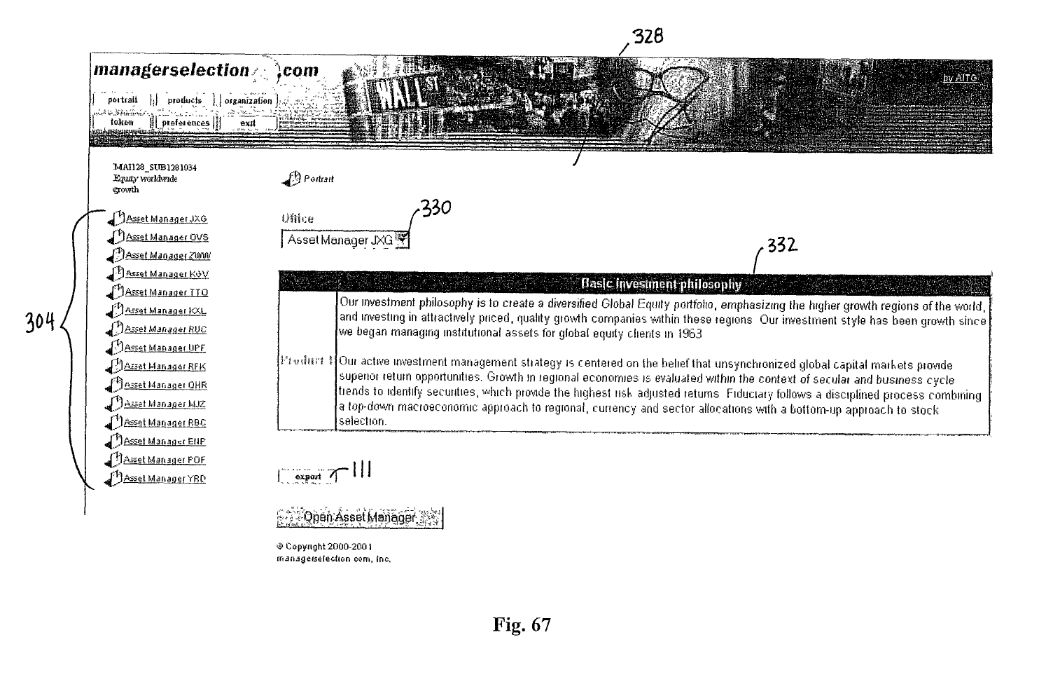

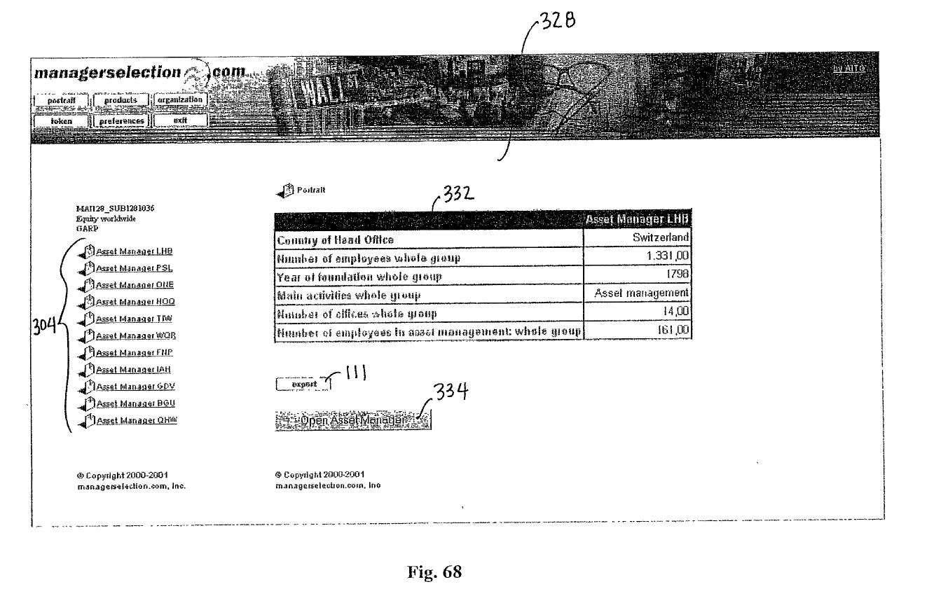

Once the investor has selected the appropriate checkboxes in the portrait section, the investor may then generate a portrait report 328, shown in FIGS. 67-68, which provides detailed portrait information 332 selected by the investor in the portrait section 318. A pull-down menu 330 provides portrait information for each asset manager 304 and product searched under the selected token. Once the investor decides on his or her favorite asset manager candidates within the token, the investor may access the contact information of the asset managers by clicking on an “open asset manager” button 334 (shown in FIG. 68), whereupon the investor may be charged a fee.

Another feature of the present invention is that feedback analysis of each successful selection of an asset manager (i.e, for each time an asset manager has been awarded a mandate to manage assets) is available to each subscribing asset manager, whether or not that asset manager was selected or even under the token searched. Such feedback analysis provides the asset manager with information on how the investor was viewing and evaluating asset manager data before reaching a decision. The feedback analysis may additionally be based on information provided by interviewing the investor who successfully selected an asset manage. The asset manager additionally receives feedback on how the asset manager's products compare with those of the selected and competing asset managers.

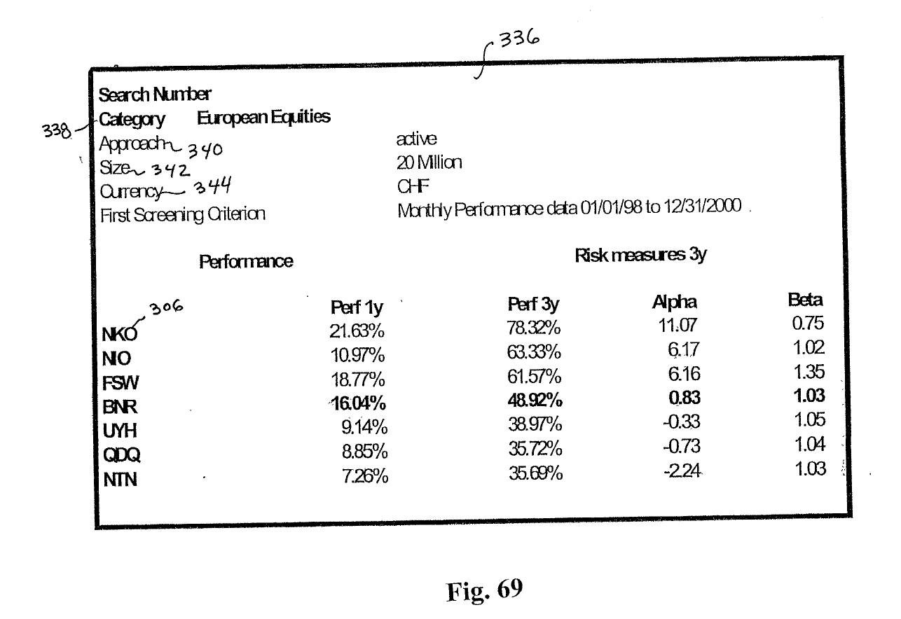

FIG. 69 shows one page of an asset manager feedback analysis report 336 and the data fields searched, including main asset category 338, approach 340, size 342 and currency 344. Also displayed are various performance figures for the asset managers under the token, identified by the code 306, under the searched token, with the asset manager 348 that awarded the mandate indicated in bold, or otherwise highlighted. The asset manager feedback analysis report 336 may be sent to the subscribing asset manager electronically (e.g., via email) or in hard form (e.g., by standard mail).

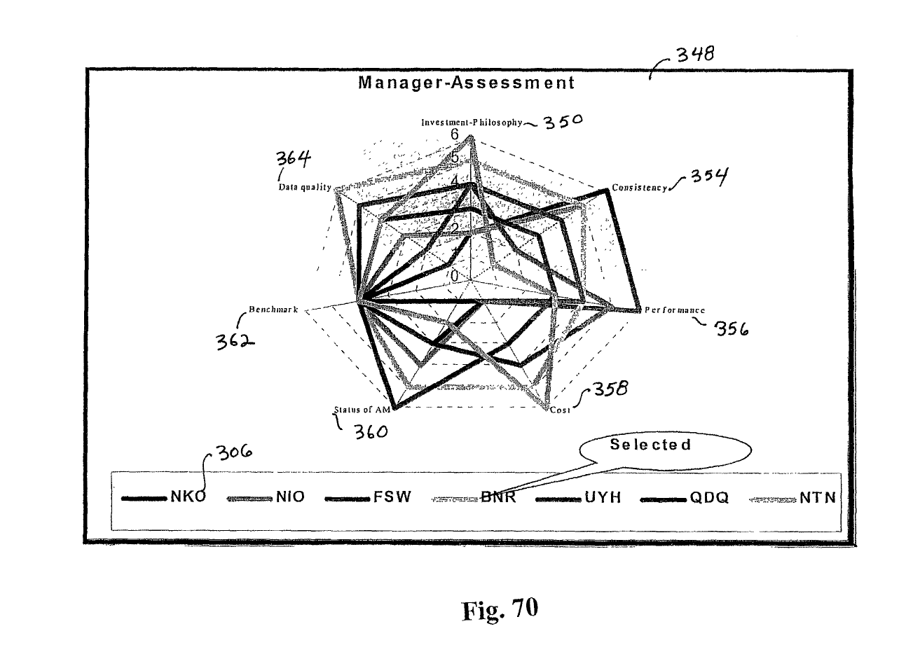

FIG. 70 shows a feedback analysis table 348, showing ranking, from first to sixth place, of the asset managers under the token 304 for a variety of fields evaluated by the investor, including investment philosophy 350, consistency 354, performance 356, cost 358, status of account manager 360, benchmark 362, and data quality 364.

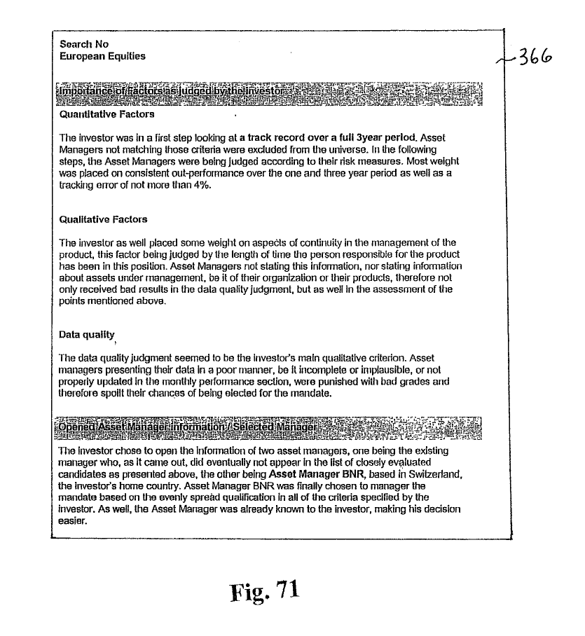

The present invention also provides the asset manager with a detailed feedback analysis commentary 366, shown in FIG. 71, for a search that has been awarded, wherein the asset manager is provided with a detailed description of the investor's behavior in successfully selecting a competing asset manager, including, but not limited to, the criteria important to the investor, where the investor set his or her main focus, qualitative factors, quantitative factors and data quality.

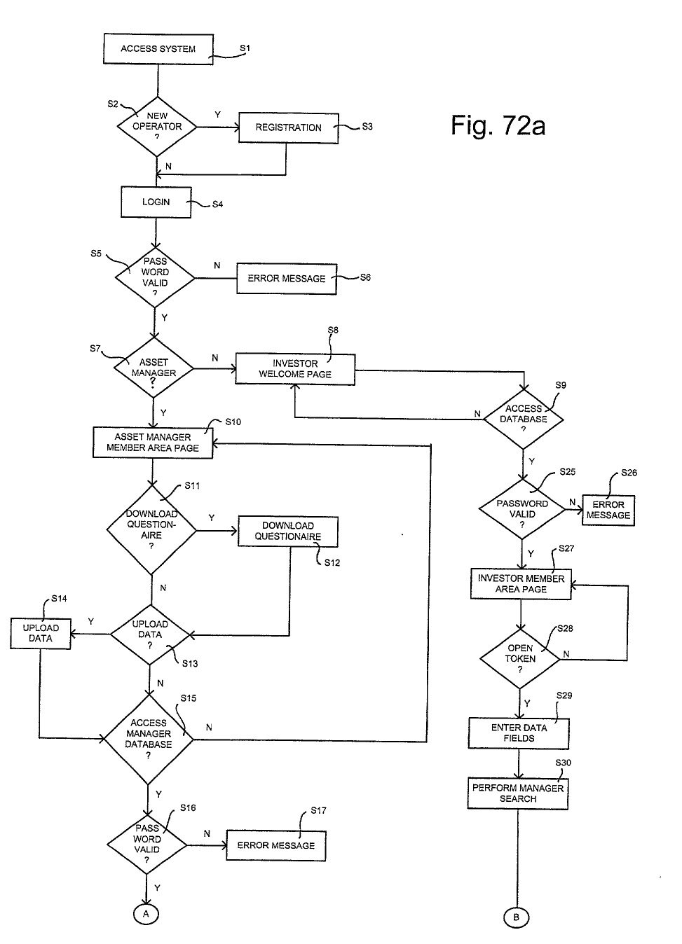

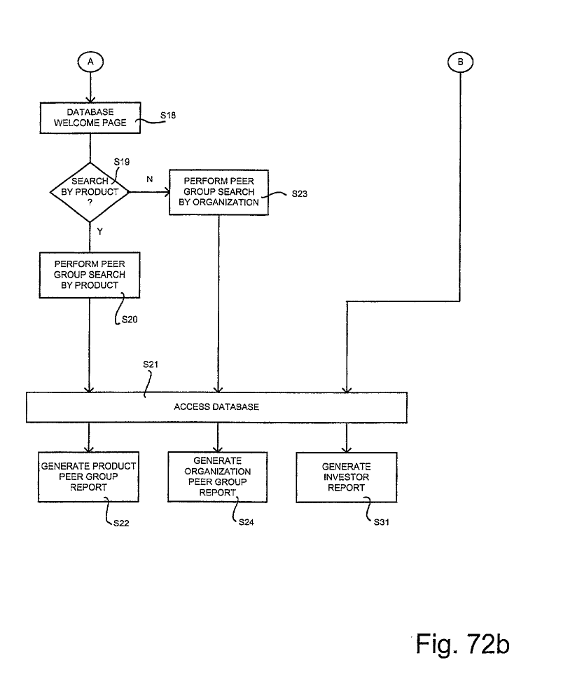

FIGS. 72a and 72b show a flowchart explaining an operation of a system of the present invention. At step S1, the operator accesses the system via the main webpage (shown in FIG. 1). At step S2, it is determined whether the operator is a new operator. If the operator is determined to be new, at step S3 the operator is prompted to enter data required for registering for the system of the present invention, after which processing proceeds to step S4, where the new operator logs in by providing his or her new username or password.

If, at step S2, it is determined that the operator is not new (i.e., that the operator is already a member), the processing proceeds to step S4, whereupon the operator logs in by providing his or her username and password. At step S5, the system authenticates the password. If the password is not valid, the processing proceeds to step S6, whereupon an error message is generated. If, at step S5, the password is valid, at step S7, the system determines, based on the username, whether the operator is an investor, consultant, or asset manager.

If, at step S7, the operator is an asset manager, the system displays a manager member area page at step S10, shown as 16 in FIG. 2, described above. At step S11, the system determines whether an electronic questionnaire is to be downloaded, and if so, at step S12, the manager is allowed to download the questionnaire. If an electronic questionnaire is not to be downloaded, at step S13, the system determines whether the manager desired to upload data. If data is to be uploaded, the asset manager is allowed to upload data to the system at step S14. If, at step S13, no data is to be uploaded, then the system, at step S15, determines whether the manager desires to access the database of the present invention.

If the manager does not wish to access the database, the system returns to step S10. If, however, the manager wishes to access the database, the system, at step S16, determines whether the manager's password is valid. If the password is not valid, an error message is generated at step S17. If, at step S16, the password is determined by the system to be valid, the process proceeds to step S18, whereat a database welcome page is presented, shown as 82 in FIG. 32, discussed above.

As discussed above, the present invention is able to search the database and generate peer group reports relating to products and organization. At step S19, the type of search to be performed is determined. If it is determined that the manager decides to search the database by product, the processing proceeds to step S20, whereat a peer group search relating to products is performed by searching the database of the system, at step S21. Once the database is searched for data relating to products, a product peer group report is generated at step S22.

If, at step S19, a search is not to be performed by product (i.e., that a search relating to organization is to be performed), the system proceeds to step S23 whereat a peer group search relating to organization is performed by searching the database of the system, at step S21. Once the database is searched for data relating to organization, an organization peer group report is generated at step S24.

If, at step S7, the system determines that the operator is not an asset manager (i.e, it is determined that the operator is an investor or consultant), the system presents the operator with an investor/consultant welcome page at step S8, shown as 240 in FIG. 58, discussed above. Next, at step S9, if the investor wishes to access the database of the present invention, the investor is prompted to enter a password. If, at step S9, the investor does not wish to access the database, the processing returns to the investor member area page of step S7. If, at step S25, the password is valid, the system displays an investor member area page at step S27, shown as 246 in FIG. 59, described above. If, however, the password is not valid, an error message is generated at step S26.

As discussed above, at the investor member area page 246 (shown in FIG. 59), wherein a variety of buttons are presented, including token 248, products 255 and exit 252. If at step S28, the user clicks on the token button 248, the user is prompted to enter data fields (shown in FIGS. 60-62 and discussed above) at step S29. If the user does not click on the token button at step S28, the user stays at the investor member area page 246 at step S27. After the data fields have been entered and the user clicks on the “make report” button 300, a manager search is performed at step S30 by accessing the database at step S21. Thereafter, the investor report is generated at step S31, an example of which is shown in FIG. 63, described above.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A financial asset manager peer group information dissemination method comprising:
accessing a database;
entering asset manager data in a section of an asset manager questionnaire, the asset manager questionnaire including a plurality of sections;
sorting, in the database, entered asset manager data from the questionnaire;
comparing asset manager data with data of at least another asset manager; and
generating a manager report of the compared data corresponding to the plurality of sections for the asset manager and the at least another asset manager.

2. The method of claim 1, further comprising displaying, in the manager report, at least one of median, smallest and largest value of the compared data for at least one section of the plurality of sections for the asset manager and the at least another asset manager.

3. The method of claim 1, further comprising displaying a comparison, in the manager report, of the compared data for at least one section of the plurality of sections.

4. The method of claim 1, wherein the manager report is configured to be exported into a spreadsheet program.

5. The method of claim 1, further comprising:
downloading the electronic asset manager questionnaire from the database; and
uploading, to a database, the asset manager questionnaire including entered asset manager data;
wherein said entering asset manager data occurs in the downloaded questionnaire.

6. The method of claim 1, wherein the sections of the questionnaire comprise at least one of organization information, products managed by the asset manager, and product details.

7. The method of claim 6, further comprising displaying a comparison, in the manager report, of at least one of organization information, products, and product details of the asset manager and the at least another asset manager.

8. The method of claim 7, further comprising displaying a comparison, in the manager report, of at least one of performance, risk measures, fees and volume of the asset manager's and the at least another asset manager's respective products.

9. The method of claim 6, further comprising displaying, in the manager report, information on the asset manager's and the at least another asset manager's respective assets under management, active portfolio volume, number of accounts active, passive portfolio volume, number of passive accounts, and preferences for a product custodian.

10. The method of claim 6, wherein the product section includes at least one category, the at least one category being one of equity bonds, hedge funds and commodities.

11. The method of claim 10, wherein the at least one category of the product section includes at least one subcategory being one of growth, value, and growth at a reasonable price (GARP).

12. The method of claim 6, wherein the product details section includes at least one category being one of product specification, assets under management, responsible portfolio manager, account size and cost, investment team, investment philosophy, reference list, management style, decision factors, actively steered parameters, approach for passive products, expected results, historic results, and performance data and standards.

13. The method of claim 11, further comprising:
entering, by an investor, data corresponding to a plurality of investor preferences corresponding to at least one of the plurality of categories and subcategories;
entering, by the investor, data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees;
matching the data corresponding to the entered plurality of investor preferences and the entered criteria with asset manager data and data entered by the at least another asset manager; and
generating an investor report based on the matched data, the investor report including a code corresponding to the asset manager and the at least another asset manager, wherein the investor is not informed of the identity of the asset manager and the at least another asset manager.

14. The method of claim 13, further comprising generating a manager feedback analysis report including factors determined important by the investor, based on feedback given by the investor.

15. The method of claim 14, wherein the factors include at least one of quantitative factors, qualitative factors, and data quality.

16. A financial asset manager peer group information dissemination system comprising:
a database;
an asset manager questionnaire including a plurality of sections, said asset manager questionnaire configured to accept asset manager data in at least one section of said plurality of sections;
a sorter that sorts, in said database, accepted asset manager data from said questionnaire;
a comparer that compares asset manager data with data of at least another asset manager; and
a manager report including compared data corresponding to said plurality of sections for the asset manager and the at least another asset manager.

17. The system of claim 16, wherein said manager report further comprises at least one of median, smallest and largest value of the compared data for at least one section of said plurality of sections for the asset manager and the at least another asset manager.

18. The system of claim 16, wherein said manager report further comprises a comparison of the compared data for at least one section of said plurality of sections.

19. The system of claim 16, wherein said manager report is configured to be exported into a spreadsheet program.

20. The system of claim 16, wherein:
said questionnaire is configured to be downloaded from said database; and
said database is configured to accept uploaded said asset manager questionnaires including accepted asset manager data;
wherein the acceptance of asset manager data occurs in said downloaded questionnaire.

21. The system of claim 16, wherein said sections of said questionnaire comprise at least one of organization information, products managed by the asset manager, and product details.

22. The system of claim 21, wherein said manager report further comprises a comparison of at least one of organization information, products, and product details of the asset manager and the at least another asset manager.

23. The system of claim 22, wherein said manager report further comprises a comparison of at least one of performance, risk measures, fees and volume of the asset manager's and the at least another asset manager's respective products.

24. The system of claim 21, wherein said manager report further comprises information on the asset manager's and the at least another asset manager's respective assets under management, active portfolio volume, number of accounts active, passive portfolio volume, number of passive accounts, and preferences for a product custodian.

25. The system of claim 21, wherein said product section includes at least one category, said at least one category being one of equity bonds, hedge funds and commodities.

26. The system of claim 25, wherein said at least one category of said product section includes at least one subcategory being one of growth, value, and growth at a reasonable price (GARP).

27. The system of claim 21, wherein said product details section includes at least one category being one of product specification, assets under management, responsible portfolio manager, account size and cost, investment team, investment philosophy, reference list, management style, decision factors, actively steered parameters, approach for passive products, expected results, historic results, and performance data and standards.

28. The system of claim 26, wherein:
said database further comprises:
A) a first acceptor that accepts first data entered by an investor, the first data corresponding to a plurality of investor preferences corresponding to at least one of said plurality of categories and subcategories;
B) a second acceptor that accepts second data entered by an investor, the second data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees; and
C) a matcher that matches the first data corresponding to the entered plurality of investor preferences and the second data corresponding to entered criteria with asset manager data and data entered by the at least another asset manager;
wherein said system further comprises an investor report based on the matched data, said investor report including a code corresponding to the asset manager and the at least another asset manager, wherein the investor is not informed of the identity of the asset manager and the at least another asset manager.

29. The system of claim 28, further comprising a manager feedback analysis report including factors determined important by the investor, based on feedback given by the investor.

30. The system of claim 29, wherein said factors include at least one of quantitative factors, qualitative factors, and data quality.

31. A computer readable medium for disseminating financial asset manager peer group information over a network, the medium comprising:
a system for accessing a database;
an asset manager questionnaire including a plurality of sections, said asset manager questionnaire configured to accept asset manager data in a said section;
a sorter that sorts, in the database, accepted asset manager data from said questionnaire;
a system that compares asset manager data with data of at least another asset manager; and
a manager report including compared data corresponding to said plurality of sections for the asset manager and the at least another asset manager.

32. The medium of claim 31, wherein said manager report further comprises at least one of median, smallest and largest value of the compared data for at least one section of said plurality of sections for the asset manager and the at least another asset manager.

33. The medium of claim 31, wherein said manager report further comprises a comparison of the compared data for at least one section of said plurality of sections.

34. The medium of claim 31, wherein said manager report is configured to be exported into a spreadsheet program.

35. The medium of claim 31, wherein:
said questionnaire is configured to be downloaded from the database; and
the database is configured to accept uploaded said asset manager questionnaires including accepted asset manager data;
wherein the acceptance of asset manager data occurs in said downloaded questionnaire.

36. The medium of claim 31, wherein said sections of said questionnaire comprise at least one of organization information, products managed by the asset manager, and product details.

37. The medium of claim 36, wherein said manager report further comprises a comparison of at least one of organization information, products, and product details of the asset manager and the at least another asset manager.

38. The medium of claim 37, wherein said manager report further comprises a comparison of at least one of performance, risk measures, fees and volume of the asset manager's and the at least another asset manager's respective products.

39. The medium of claim 36, wherein said manager report further comprises information on the asset manager's and the at least another asset manager's respective assets under management, active portfolio volume, number of accounts active, passive portfolio volume, number of passive accounts, and preferences for a product custodian.

40. The medium of claim 36, wherein said product section includes at least one category, said at least one category being one of equity bonds, hedge funds and commodities.

41. The medium of claim 40, wherein said at least one category of said product section includes at least one subcategory being one of growth, value, and growth at a reasonable price (GARP).

42. The medium of claim 36, wherein said product details section includes at least one category being one of product specification, assets under management, responsible portfolio manager, account size and cost, investment team, investment philosophy, reference list, management style, decision factors, actively steered parameters, approach for passive products, expected results, historic results, and performance data and standards.

43. The medium of claim 41, wherein:
the database further comprises:
A) a first acceptor that accepts first data entered by an investor, the first data corresponding to a plurality of investor preferences corresponding to at least one of said plurality of categories and subcategories;
B) a second acceptor that accepts second data entered by an investor, the second data corresponding to criteria including at least one of historical performance, historical low standard deviation, historical high standard deviation, historical performance/standard deviation, low tracking error in original currency, low tracking error in chosen currency, high tracking error in original currency, high tracking error in chosen currency, low information ratio in original currency, low information ratio in chosen currency, high information ratio in original currency, high information ratio in chosen currency, low alpha in original currency, low alpha in chosen currency, high alpha in original currency, high alpha in chosen currency, low beta in original currency, low beta in chosen currency, high beta in original currency, high beta in chosen currency, and fees; and
C) a system that matches the first data corresponding to the entered plurality of investor preferences and the second data corresponding to entered criteria with asset manager data and data entered by the at least another asset manager;
wherein said medium further comprises an investor report based on the matched data, said investor report including a code corresponding to the asset manager and the at least another asset manager, wherein the investor is not informed of the identity of the asset manager and the at least another asset manager.

44. The medium of claim 43, further comprising a manager feedback analysis report including factors determined important by the investor, based on feedback given by the investor.

45. The medium of claim 44, wherein said factors include at least one of quantitative factors, qualitative factors, and data quality.
